(19) United States
(12) Patent Application Publication
(10) Pub. No.: US 2023/0161084 A1
(43) Pub. Date: May 25, 2023

(54) DIFFUSER WITH MAGNET DRIVE

(71) Applicant: WayRay AG, Zürich (CH)

(72) Inventor: Nikita Chistikov, Moscow (RU)

(21) Appl. No.: 17/913,004

(22) PCT Filed: Mar. 24, 2020
(86) PCT No.: PCT/IB2020/000233

§ 371 Date: Sep. 20, 2022

(51) Int. Cl. G02B 5/02; G02B 27/01

(52) U.S. Cl. CPC G02B 5/0242; G02B 27/0101; G02B 2027/0145

(57) ABSTRACT

Disclosed embodiments are related to diffuser mechanisms for projector-based systems, such as head-up displays, virtual/augmented reality systems, and the like. A diffuser is provided, which includes a diffuser screen through which emitted laser light is transmitted. The diffuser includes suspension elements oriented perpendicular to the diffuser screen, or has any other orientation that allows or enables diffuser screen movement in a diffuser screen plane. The diffuser reduces speckle and smooths projected images by means of closed-loop circular or reciprocating movement of the diffuser screen in a diffuser screen plane. Other embodiments may be disclosed and/or claimed.

### FIELD

Embodiments discussed herein are related to speckle reduction arrangements and diffusing elements, and in particular, to speckle diffusers for use in Head-Up Display (HUD) systems.

### BACKGROUND

Optical (display) systems, such as holographic Head-Up Displays (HUDs), may use laser light projection devices (“projectors”). Lasers are ideal light sources for projectors due to their power efficiency, brightness, and color gamut ranges. However, laser light projectors may produce images with deteriorated quality in comparison to other display devices that emit light directly on to a screen. This is because Laser-illuminated surfaces often produce speckle noise or a speckle pattern (collectively referred to as “speckle”). Speckle is a granular pattern of bright and dark regions of intensity that occurs when laser light is scattered (or reflected) from a rough surface. Speckle in projected images may cause eye strain, which may result in user/observer headaches among other issues. Speckle diffuser devices (also referred to as “speckle diffusers” or “diffusers”) are devices used in optics to destroy spatial coherence (or coherence interference) of laser light prior to reflection from a surface.

Conventional diffusers reduce speckle through temporal averaging of the irradiance pattern using a diffractive element, such as a glass lens. The temporal averaging occurs from rotation or vibration of the diffractive element. As the diffuser moves (e.g., rotates or vibrates), the diffuser may average out the undesirable effect of speckle by making a coherence time much smaller than the exposure time. Other more recently developed diffusers use mechanical motion to diffuse speckle. One of the problems of these mechanical diffusers is that the motion of the frame to diffuse speckle may also cause the diffuser itself to vibrate. Additionally, many mechanical diffusers only provide one direction of reciprocal motion (e.g., vertical or horizontal), which requires the frequency of the motion to be greater than 24 Hertz (Hz) in order to eliminate speckling for the human visual system. Furthermore, many mechanical diffusers are constructed using many parts, which increases the complexity, cost, and resources required for manufacturing such devices. Moreover, the motion produced by mechanical diffusers causes friction and wear on the device, which limits the overall lifespan of the diffuser.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings:

FIG. 1 schematically illustrates a Head-Up Display (HUD) system using a projector with laser light source, according to various embodiments.

FIG. 2 illustrates a perspective view of a diffuser device according to various embodiments.

FIG. 3 illustrates a frontal view of the diffuser device according to various embodiments.

FIG. 4 illustrates an exploded view of the diffuser device according to various embodiments.

FIG. 5 illustrates a side or top view of the diffuser device according to various embodiments.

FIG. 6 illustrates another perspective view of a diffuser device according to various embodiments.

FIG. 7 illustrates example actuation elements, according to various embodiments.

FIGS. 8 and 9 illustrate example movement models for a diffuser device of the embodiments of FIGS. 2-7.

FIG. 10 illustrates an example HUD system for a vehicle according to various embodiments.

FIG. 11 illustrates an example display system configurable to interface with an on-board vehicle operating system according to various embodiments.

FIG. 12 illustrates an example implementation of a vehicle embedded computer device according to various embodiments.

### DETAILED DESCRIPTION

The following detailed description refers to the accompanying drawings in which are shown, by way of illustration, embodiments that may be practiced. The same reference numbers may be used in different drawings to identify the same or similar elements. Various operations may be described as multiple discrete operations in turn, in a manner that may be helpful in understanding embodiments; however, the order of description should not be construed to imply that these operations are order-dependent. The description may use perspective-based descriptions such as up/down, back/front, top/bottom, and the like. Such descriptions are merely used to facilitate the discussion and are not intended to restrict the application of disclosed embodiments.

In the following description, for purposes of explanation and not limitation, specific details are set forth such as particular structures, architectures, techniques, etc. in order to provide a thorough understanding of various aspects of the embodiments. However, in certain instances, descriptions of well-known elements, devices, components, circuits, methods, etc., are omitted so as not to obscure the description of the embodiments with unnecessary detail. It will be apparent to those skilled in the art having the benefit of the present disclosure that aspects of the embodiments may be practiced in ways that depart from the specific details discussed herein. It is to be understood that other embodiments may be utilized and structural or logical changes may be made without departing from the scope of the present disclosure. Therefore, the following detailed description is not to be taken in a limiting sense.

Embodiments discussed herein include a diffuser for laser projectors. The laser projector may include a laser light source to generate laser light. The diffuser may be used in or with any type of projector to reduce speckle and smooth projected images. The diffuser includes a diffuser screen (e.g., a mated glass plate, a mated minor, and/or the like) through which laser light emitted from the laser light source is transmitted. The diffuser is capable of reducing speckle noise generated in an image of the projected light by vibrating and/or oscillating the diffuser screen. This also smooths out images produced by the projected light. The diffuser reduces speckle and smooths projected images by means of closed-loop circular or reciprocating movement of the diffuser screen in a diffuser screen plane. The diffuser includes a drive mechanism that provides noiseless (or almost noiseless) drive operation achieved by the absence of friction pairs in the diffuser. The absence of friction pairs in the diffuser reduces or eliminates mechanical wear, which allows the diffuser to have an extended lifespan (as compared to conventional diffusers). The diffuser utilizes suspension elements, such as rods or the like, where axes of the rods are oriented perpendicular to the diffuser screen work plane, which allows removal of guides, rails, and/or other structural elements that are used by conventional diffusers to guide the movement trajectory of the diffuser screen. Removal of these elements allows the lifetime of the diffuser to be increased. This also reduces the number of components of the diffuser, which reduces manufacturing complexity. The diffuser may consume less energy (as compared to conventional diffusers) by operating the drive mechanism at a resonance frequency of the diffuser or the system in which the diffuser is implemented. Other embodiments may be described and/or claimed.

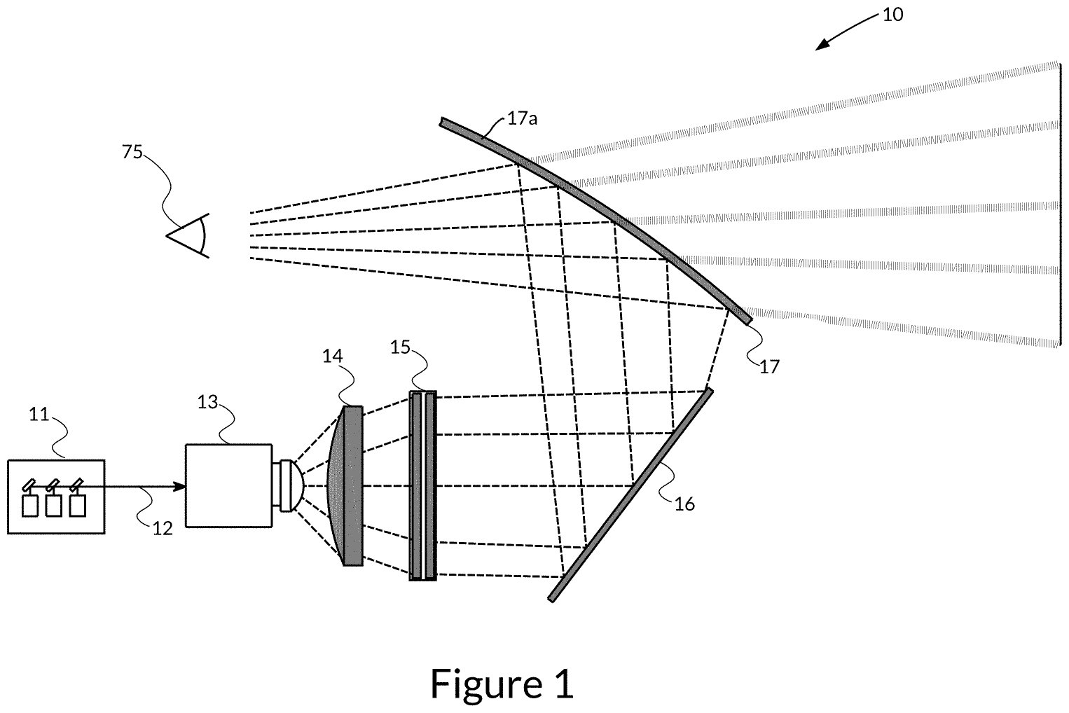

Referring now to the figures, FIG. 1 illustrates an example projection system 10 using a projector 13 with a laser light source 13, according to various embodiments. The projection system 10 comprises a laser light source 11, a projector unit 13, an optical element 14, a diffuser screen 15, an imaging matrix 16, and a screen 17 such as a vehicle windshield, head-mounted display screen/glass, or the like. In the example of FIG. 1, the laser light source 11 generates laser light 12, which is projected by the projector unit 13. The projector unit 13 generates and/or projects light representative of at least one virtual image through optical element 14, diffuser screen 15, and onto the screen 17 when reflected or otherwise guided by the imaging matrix 16.

In some implementations, the optical element 14 is or includes a collimator (e.g., a lenses set (including one or more lenses), apertures, etc.) that changes diverging light from the light source 11 into parallel beam(s). In some implementations, the optical element 14 may include or be a combiner (also referred to as “combiner optic” or the like), which may combine different light paths into one light path to define a palette of colors. In some implementations, the optical element 14 may comprise scanning minors that copy the image pixel-by-pixel and then project the image for display. In some implementations, the optical element 14 may be omitted. The placement of the aforementioned optical elements 14 may vary from embodiment to embodiment, depending on the implementation used.

The light/beam(s) passing through the optical element 14 further pass through diffuser screen 15 and onto an imaging matrix 16. Imaging matrix 16, in turn, selectively distributes and/or propagates the virtual image received as light/beam(s) from projector unit 13 via optical element 14 and/or diffuser screen 15 as one or more wave fronts to a screen 17. In some examples, screen 17 is a vehicle windshield, a holographic film 17a placed on or adjacent to screen 17, or a combination thereof. As examples, imaging matrix 16 may comprise one or more mirrors, a liquid crystal display (LCD), a digital micro-mirror device (DMD), a microelectromechanical (MEMS) laser scanner, a liquid crystal on silicon (LCoS) matrix, a matte glass with a projected image, other types of imaging matrices, or any combination thereof. In some embodiments, imaging matrix 16 may be, or may be included in, projector unit 13 (or a PGU 1230 as discussed infra). In some implementations, the imaging matrix 16 may be omitted.

In some implementations, the projection system 10 comprises a transparent holographic film 17a embedded in, or otherwise affixed to the screen 17. The holographic film 17a may be alternatively placed on a screen 17 (not shown separately from system 10) and/or placed between observer 75 and screen 17. In some examples, holographic film 17a may comprise a plurality of collimators embedded in the film 17a for collimating and/or combining light emitted from an imaging matrix 16 with the images of real-world objects passing through the film 17a towards observer 75. It may be useful to develop a projector system 10 having a long lifetime, with low power consumption and/or with a relatively noiseless operation for projector system 10 and/or for HUDs in various types of vehicles.

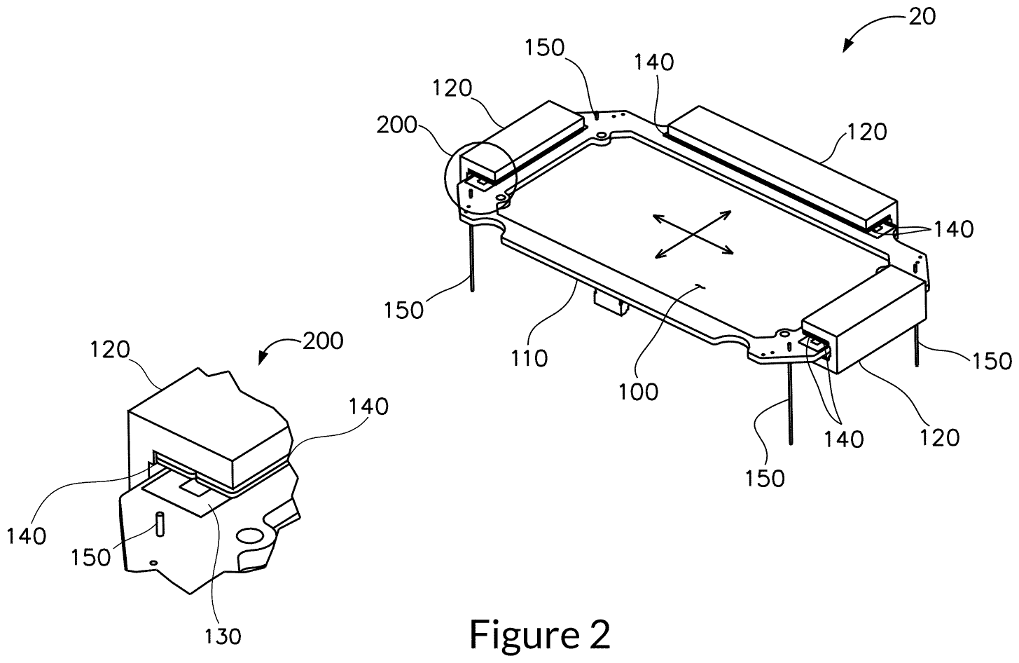

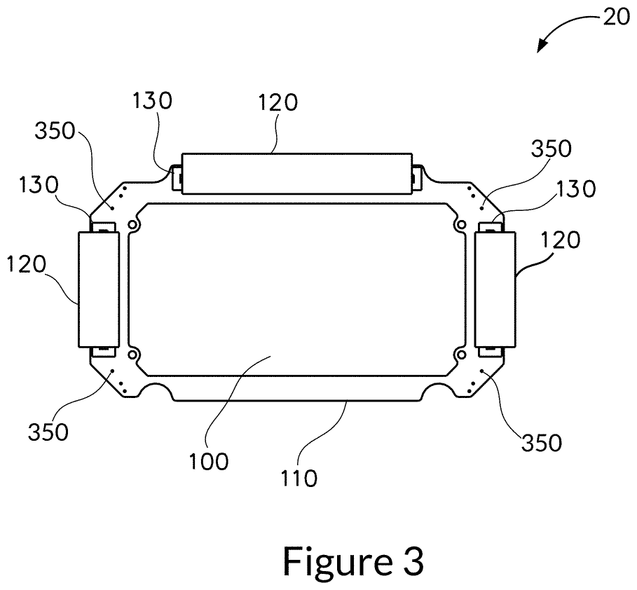

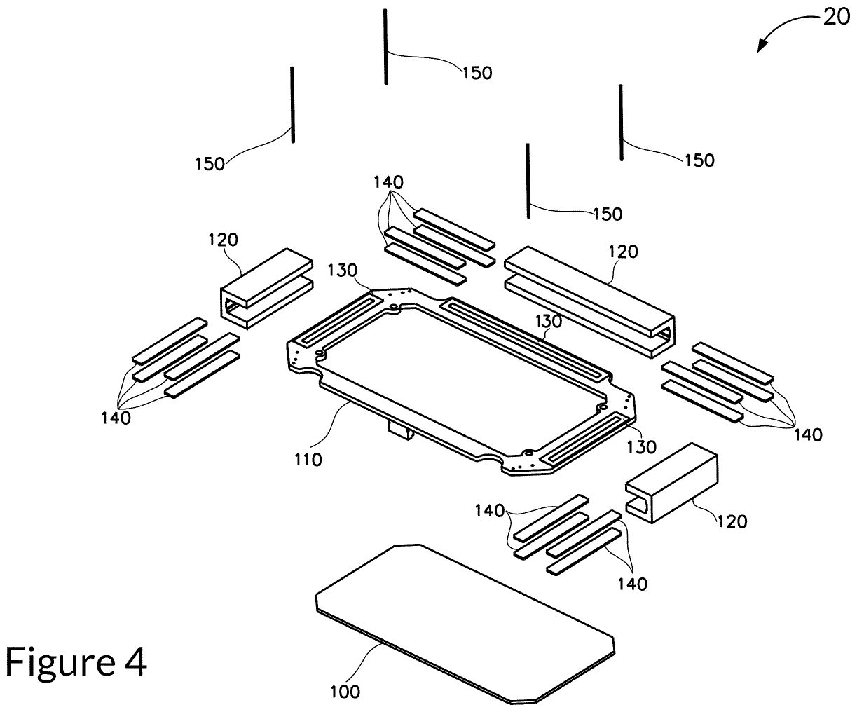

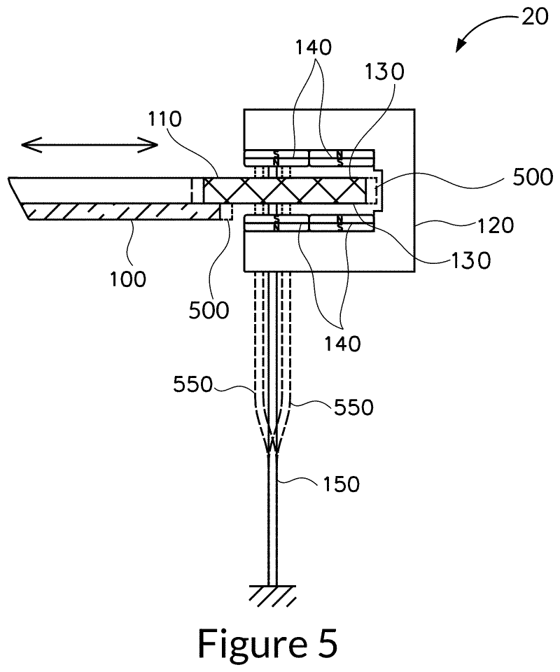

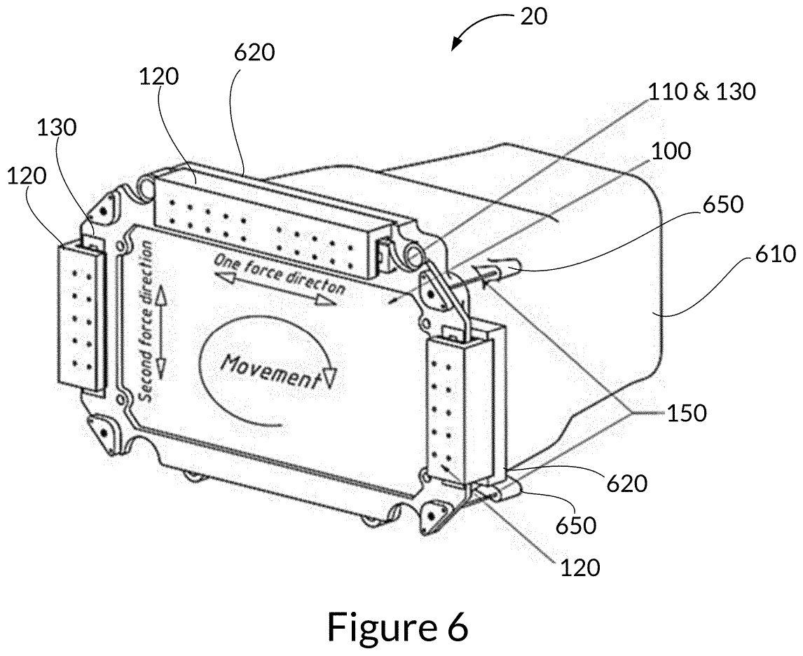

Referring now to FIGS. 2-6, which illustrate various views of an example speckle diffuser device 20 according to various embodiments. In particular, FIG. 2 illustrates a perspective view of the diffuser device 20 according to various embodiments, FIG. 3 illustrates a frontal view of the diffuser device 20 according to various embodiments, FIG. 4 illustrates an exploded view of the diffuser device 20 according to various embodiments, FIG. 5 illustrates a side view of the diffuser device 20 according to various embodiments, and FIG. 6 illustrates another perspective view of the diffuser device 20 according to various embodiments. The speckle diffuser 20 may be used with a laser projector according to various embodiments. The diffuser device 20 is used for applying vibrations, oscillations, and/or other motions to a speckle diffuser element 100. The diffuser element 100 is operable to transmit (or reflect) laser light projected on or through the diffuser element 100.

As shown by FIGS. 2-6, the diffuser device 20 comprises a diffuser element 100 (also referred to as “diffuser element 100,” “diffuser 100,” and the like), a frame 110, one or more coils 112, one or more interaction elements 140, one or more fixed elements 120, and one or more suspension elements 150. In the illustrated embodiments, the diffuser device 20 includes four suspension elements 150 and three magnet mounts 130; however, other embodiments may include any number of suspension elements 150 and/or any number of magnet mounts 130.

The diffuser element 100 is mounted in or on the frame 110, or otherwise coupled to the frame 110 using any suitable fastening means. The frame 110 including the diffuser element 100 may be referred to as a “diffuser subassembly” or the like. The diffuser element 100 may be made of any suitable material, such as glass, mate glass, ground glass, silica, fused silica, opal, ceramic materials, sapphire, quartz, calcium fluoride (CaF2), magnesium fluoride (MgF2), zinc selenide (ZnSe), plastic, mate plastic, polymethyl methacrylate (PMMA), and/or the like and/or combinations thereof. In some implementations, the diffuser element 100 is or includes a microlenses array diffuser (e.g., with a size of about 10 micrometers (μm) to less than one millimeter (MM)) such as, for example, an array of gradient-index (GRIN) lenses, an array of micro-Frensnel lenses, an array of binary-optic microlenses, microlens arrays with circular apertures, microlens arrays with non-circular apertures. The diffuser element 100 may have a geometry/shape (e.g., dimensions (height, width, depth) and curvature (concave, flat, convex, etc.)) depending on the shape and features of the structure/frame 110 of the device 20, and/or may be application/implementation dependent. The diffuser element 100 may be manufactured or formed using any suitable fabrication means.

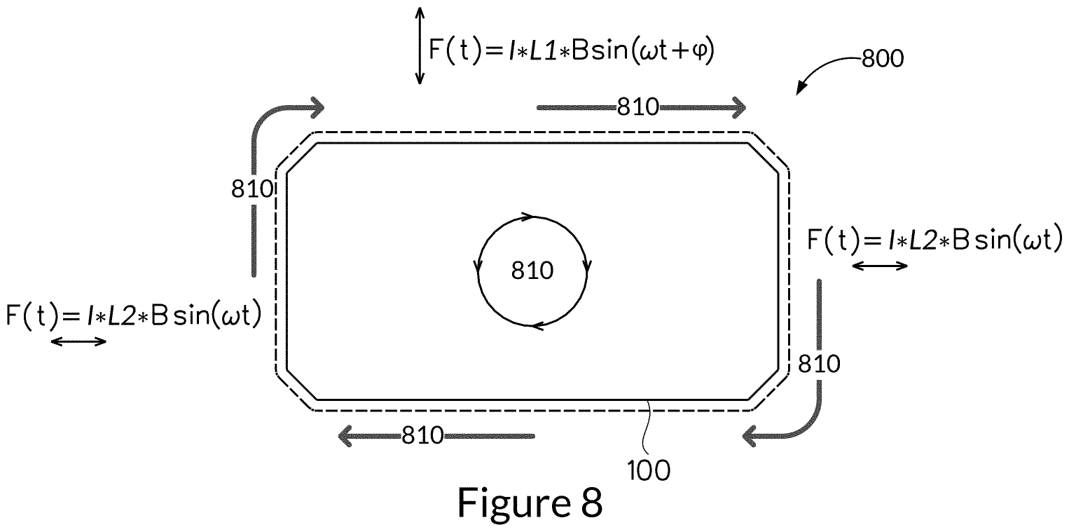

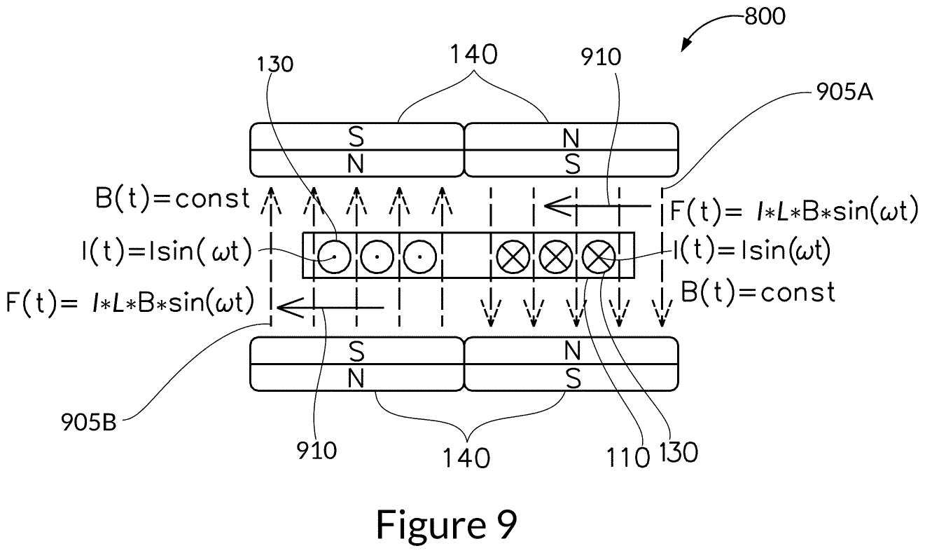

The frame 110 holds or otherwise supports the diffuser element 100 during oscillation, vibration, shaking, or other movements in a diffuser plane. The movements or motions may be in any direction in the diffuser plane and/or may include any trajectory including rotational movements. In the example of FIG. 2, the diffuser plane is depicted by the crossed lines in the center portion of the diffuser element 100 with arrows at each end of each line. Rotational movements are discussed infra with respect to FIGS. 8 and 9. In some implementations, the frame 110 may be a printed circuit board (PCB). However, the frame 110 may be made of any suitable material (or combination or materials) such as phenolics or phenol formaldehyde (PF) including phenolic paper impregnated with a phenal resin or PF resin, fiberglass and/or fiberglass impregnated with an epoxy resin, carbon fiber, matte glass with polyester, polytetrafluoroethylene (PTFE), ceramic filled PTFE, aluminum, aluminum oxide (alumina), polymide, polyvinyl chloride (PVC), polycarbonate (PC), polyimide(s), acrylonitrile butadiene styrene (ABS), polyetheretherketone (PEEK), polyaryletherketone (PAEK), polydiketoenamine (PDK), an oxide material (e.g., silicon oxide (SiO), silicon dioxide (SiO2), etc.), ferromagnetic metals or alloys (e.g., iron, nickel, cobalt, gadolinium, dysprosium, steel, steel alloys, etc.) with some dielectric coating or laminate, and/or any other suitable material and/or any combination thereof. The frame 110 may be manufactured or formed using any suitable fabrication means. Furthermore, the geometry (shape) of the frame 110 may be different from the depicted shape in the example of FIGS. 2-6 depending on the shape and features of the diffuser element 100.

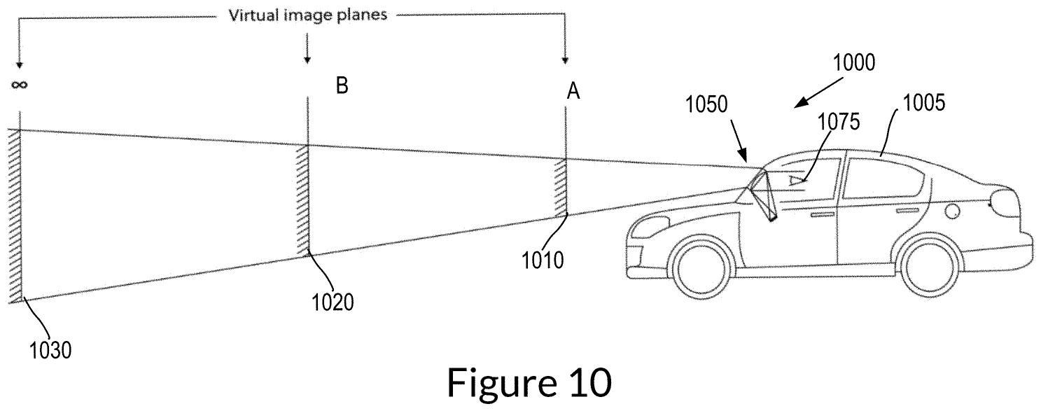

The speckle diffuser 20 is mounted in a projection system (e.g., HUD system 1000 of FIG. 10, a virtual reality (VR) and/or augmented reality (AR) display system, or the like) using one or more suspension elements 150. In embodiments, the suspension elements 150 are rods (or “suspension rods” 150), however, other embodiments may use other suspension means. Each suspension element 150 is inserted into respective holes (or vias) 350 in the frame 110 (see e.g., FIG. 3), such that each suspension element 150 is perpendicular (or substantially perpendicular) with the frame 110 (see e.g., FIGS. 2 and 5). In other embodiments, the suspension elements 150 may have some other position, orientation, and/or arrangement that allows or enables the diffusor element 100 motion in the diffusor plane. As shown by FIG. 6, the suspension elements 150 are also coupled to a housing 610, which may be manufactured or formed using any suitable fabrication mean. In particular, in FIG. 6 one end of each suspension element 150 is inserted into, or received by, a respective rod receptacle 650 that is formed into (or otherwise attached to) the housing 610; and a second end of each suspension element 150 is inserted into, or through, holes 350 (not labeled in FIG. 6). In various embodiments, the suspension elements 150 are perpendicular (or substantially perpendicular) to the frame 110 (and diffuser element 100) to allow the diffuser element 100 to move cyclically or elliptically. The perpendicular orientation of the suspension elements 150 provides the diffuser element 100 with more degrees of freedom to move in any direction in the diffuser plane (see e.g., FIGS. 6 and 8-9), as compared to existing speckle diffusion mechanisms.

The suspension elements 150 may be made of (or formed from) any suitable material that allows the frame 110 with the diffuser element 100 to move in any direction in the diffuser element plane and fix the frame 110 with the diffuser element 100 in any other direction. The material of the suspension elements 150 should be flexible enough to accommodate the oscillations, vibrations, and/or other movements of the frame 110 with the diffuser element 100. As shown by FIG. 5, the flexibility of the suspension element 150 is shown flex amount 550 (and the dashed lines). FIG. 5 also shows a displacement 500 of the frame 110. For example, in some embodiments, the suspension elements 150 are flexible enough to allow movement of the diffuser element 100 in about 0.01 millimeter (mm) in any direction in the diffuser plane. As examples, the suspension elements 150 may be made or formed of carbon, graphite (e.g., crystalline carbon), carbon fiber, fiber glass, ceramic filled PTFE, aluminum, aluminum oxide (alumina), polymide, PVC, PC, polyimide(s), ABS, PEEK, PAEK, PDK, an oxide material (e.g., SiO, SiO2, etc.), steel, carbon steel, spring steel, steel alloys (e.g., including alloying elements in addition to iron and carbon), and/or any other suitable material and/or any combination thereof. In some embodiments, the diameter of each suspension element 150 is about 0.05 mm, although the diameter of the suspension elements 150 may be different in other embodiments. The diameter of the holes 350 may be drilled or formed large enough to securely accommodate the suspension elements 150. The suspension elements 150 may be manufactured or formed using any suitable fabrication means.

As shown by FIGS. 2-6, the diffuser device 20 also includes actuation subassemblies, each of which includes a fixed element 120, actuation element 130, and interaction element 140. The fixed element 120, actuation element 130, and interaction element 140 may be manufactured or formed using any suitable fabrication means, including a same or different fabrication means for each of the fixed element 120, actuation element 130, and interaction element 140. As shown by FIG. 6, each of the fixed elements 120 are coupled to a housing 610 (also referred to as “optical case 610”). As examples, the housing 610 may be a VR/AR headset housing/case, a HUD system housing, or the like. The housing 610 may be made of any suitable materials, such as any of those discussed herein or combinations thereof.

Each fixed element 120 is coupled to a corresponding section 620 of the housing 610. The coupling of the fixed elements 120 to sections 620 of the housing 610 may be done by way of any suitable fastening means. Each interaction element 140 is coupled to a corresponding fixed element 120. In embodiments, the interaction elements 140 are mounted on the fixed elements 120 according to their polarity in order to provide a magnetic (or electromagnetic) force in the directions as shown by the arrows in FIGS. 2,5-6, and 8-9. Additionally, actuation elements 130 are attached to, or embedded in the frame 110, as shown by FIGS. 2-7.

As shown by FIGS. 2-3 and 5-6, each fixed element 120 overlaps a respective portion of the frame 110 that includes an actuation element 130. Each fixed element 120 holds a respective interaction element 140 such that a face of the respective interaction element 140 faces a corresponding actuation element 130 in/on the frame 110. As shown by FIG. 5, the actuation elements 130 are attached to, or mounted on, both sides of the frame 110. FIG. 5 shows that each fixed element 120 has two prongs and forms a “C” or “U” shape, and interaction elements 140 are fixed to an inner surface of each prong. Here, the inner surface is a surface of each prong that faces the other prong or actuation element 130 on a surface of the frame 110. As discussed in more detail infra, each actuation element 130—interaction element 140 pair (also referred to as “actuation pair 130-140,” or the like), generates a motive force that vibrates and/or oscillates the diffuser element 100 to reduce speckle from generated light.

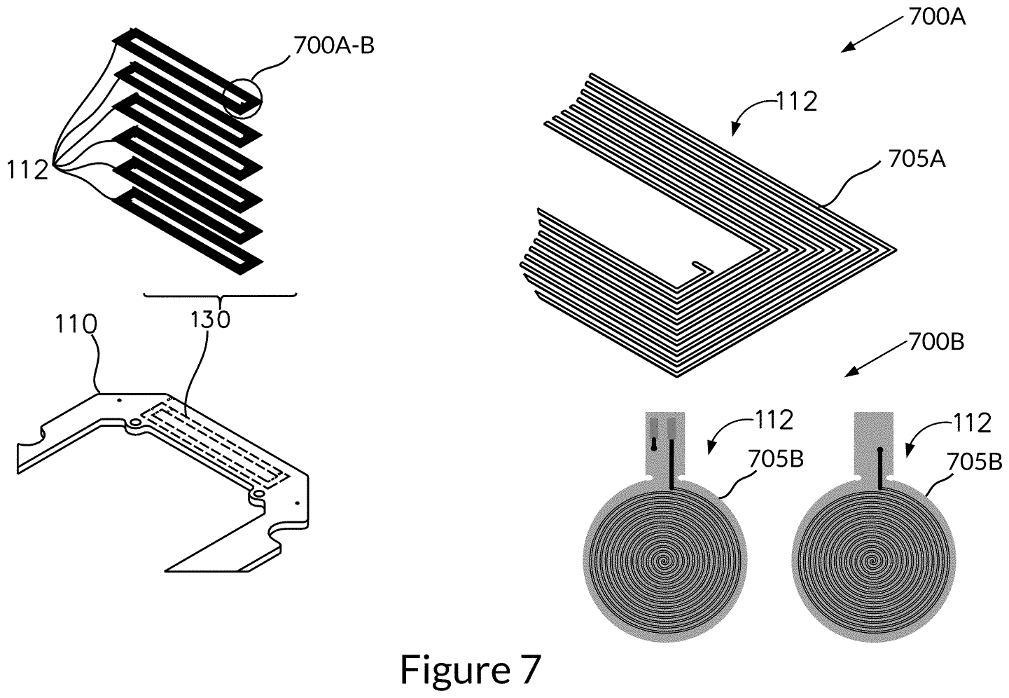

In various embodiments, the interaction elements 140 and/or the actuation elements 130 are magnets. In some embodiments, the interaction elements 140 are magnets including permanent magnets, ferromagnetic materials (e.g., including magnetically soft materials such as iron, or magnetically hard materials such as alnico and ferrite), rare-earth magnets (e.g., samarium-cobalt (SmCo) magnets, neodymium-iron-boron (NdFeB or “NIB”) magnets, etc.), composite magnets (e.g., ceramic or ferrite magnets, flexible magnets (e.g., ferric oxide mixed with a plastic binder), aluminum-nickel-cobalt (alnico) magnets, etc.), and/or the like. In other embodiments, the interaction elements 140 may include one or more electromagnets each of which are formed from one or more coils or solenoids. In these embodiments, each of the coils may (or may not) be wrapped around a ferromagnetic soft material such as iron, steel, and/or the like. Alternatively, the electromagnets of the interaction elements may be the same or similar to those discussed in FIG. 7. In any of the aforementioned embodiments, the actuation elements 130 may comprises one or more electromagnets, which are discussed in more detail with respect to FIG. 7.

FIG. 7 shows an example actuation element 130, where the frame 110 is a multi-layer PCB (also referred to as “PCB 110” or the like). The actuation element 130 includes a plurality of layers 112 making up the actuation element 130. The layers 112 may also correspond to, or be part of, individual conductor layers of the PCB 110. Each layer 112 includes one or more coils 705 (or microcoils 705).

Each coil 705 (e.g., coil 705A or coil 705B) may be formed from a single trace (e.g., copper circuit trace) that coils around itself in a spiral or spiral-like pattern, examples of which are shown by magnified views 700A an 700B. In particular, magnified view 700A shows a rectangular coil pattern 705A (also referred to as “coil 705A” or “coils 705A”), and magnified view 700B shows both sides of a circular coil pattern 705B (also referred to as “coil 705B” or “coils 705B”). Other coil arrangements/patterns may be used such as a square coil pattern, elliptical coil pattern, and/or some other polygon coil pattern. Additionally or alternatively, the coil patterns/arrangements may include a variety of meandering turns or loops. Additionally or alternatively, multiple different coil patterns may be used.

Each layer 112 of the actuation element 130 (and the PCB 110) is stacked on top of each other and interconnected to make continuous traces thereby creating planar electrical coils 705. stacked inductive coils 705 are created by stacking the layers 112 on top of each another, and by connecting the individual coils 705 together by vias in the PCB 110. Additionally, multiple coils 705 may be arranged with respect to one another, and with respect to a corresponding interaction element 140, in such a way as to create a linear drive, linear motor, linear induction motor (LIM), moving coil motor, and/or similar structure. For example, the coils 705 disposed or placed next to each other may have opposite winding directions to create different magnetic field poles to attract or repel a magnetic field created by magnets of the interaction element 130.

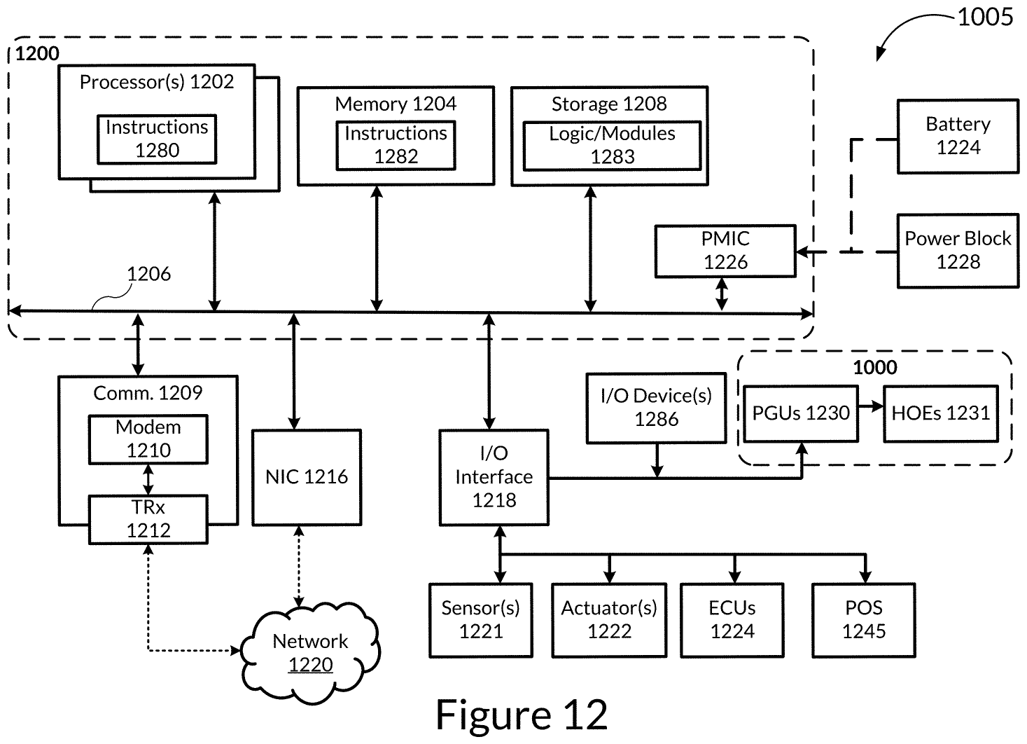

In order to operate the actuation, electric current is supplied to the coil(s) 705 of each actuation element 130. The electric current propagated through each coil 705 generates a magnetic field that flows through the center of each coil 705 along its longitudinal axis. The magnetic field produced by the current is oriented perpendicular to the direction of the current flow, and the direction of the magnetic field depends on the direction of the flow of current. Any suitable power or electrical current supply means/power supply means (e.g., battery 1224 and/or power block 1228 of FIG. 12) may be used to supply the current to coils 705, and the specific means for supplying current to the coil(s) 705 should be well within purview of one skilled in the art.

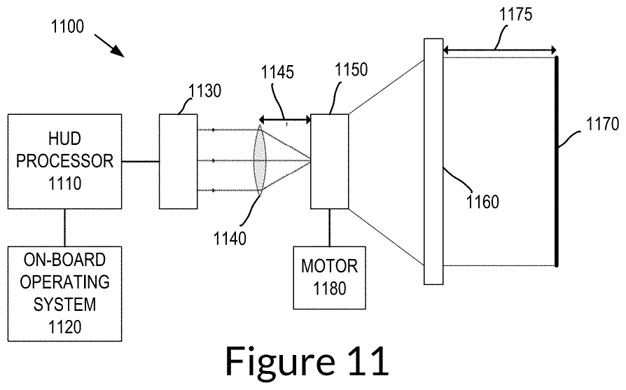

For example, the powering on/off of the actuation element 130 and the amount of current supplied to the actuation element 130 (which may affect the strength and direction of the electromagnetic field of the actuation element 130) may be controlled by a controller. The controller is operable or configurable to provide varying amounts of current (or varying pulses of current) to the coils 705 in order to control the strength and direction of the magnetic fields. Different magnetic field strengths may provide different oscillation/vibration frequencies for the diffuser element 100, which may provide speckle diffusion for various frequencies/magnitudes of laser light 12. Most oscillation frequencies can be achieved using various combinations of current pulses, for example, using phase offset modulation, pulse-width modulation, and/or other like modulation schemes. The controller may be any suitable computing device (see e.g., FIG. 12), such as a microprocessor or special-purpose processor specifically built and configurable to control the actuation element 130 (hereinafter referred to as a “controller”). Well known power/ground connections power source(s), to integrated circuit (IC) chips and other components are not shown within FIGS. 1-9 for simplicity of illustration and discussion, and so as not to obscure the disclosure the illustrated embodiments. As examples, an electronic control unit (ECU) 1224, an actuator 1222, a microcontroller or microprocessor of a PGU 1230 (see e.g., discussion with regard to FIGS. 11-12 infra) may be the controller that supplies current to the actuation element 130.

FIGS. 8 and 9 illustrate a movement model 800 of the diffuser device 20 according to various embodiments. FIG. 8 illustrates a frontal view of the diffuser device 20 and FIG. 9 illustrates a top view of the diffuser device 20. As mentioned previously, motion of the speckle diffuser 20 is initiated when each actuation element 130 is powered on and interacts via magnetism with a corresponding interaction element 140. The magnetic field created by the actuation elements 130 interacts with the interaction elements 140 (e.g., permanent magnets, ferromagnets, magnetic conductors, etc.) fixed or attached to the fixed elements 120 of the diffuser device 20. This causes motion in a similar manner as a linear drive, linear motor, LIM, moving coil motor, or the like. The combination of the movements generated by each actuation pair 130-140 results in a circular or elliptical movement 810 of the frame 110, as is shown by FIG. 8. Additionally or alternatively, pulsing the current through individual actuation elements 130 at different rates, strengths, and/or times may cause oscillation/vibration of the diffuser element 100.

In the example of FIGS. 8 and 9, the resulting force generated by the magnetic fields is based on the strength of the magnetic field of the interaction elements 140, the amount of current through the coils 705 (I), and the length of the wire making up the coils 705 (1). Referring to FIG. 8, lateral movements are expressed using F(t)=I*L2*B*sin(ωt) and vertical movements are expressed using F(t)=I*L1*B*sin(ωt+φ), where F is the force or drive force, L1 and L2 are the total lengths of conductor that interact with the magnetic field produced by magnetics, B is an amplitude (e.g., the maximum displacement from the equilibrium position) for each wave, w is the frequency (or angular frequency, e.g., ω=2πf, where f is the ordinary frequency or number of oscillations), t is time, and φ is a phase shift or phase constant (e.g., the initial phase).

Referring to FIG. 9, the depicted interaction element 140 in this embodiment comprises a plurality of magnets (e.g., rare-earth magnets or the like) mounted in alternating polarity on the fixed elements 120 (not shown), where the label “S” represents a south pole and the label “N” represents a “north pole.” The magnets produce magnetic fields 905A and 905B perpendicular to the frame 110, and flowing in opposite directions to one another. B(t) represents the magnetic field density or magnetic flux density of the magnetic fields 905A and 905B, and “const” is a constant value.

In various embodiments, a power supply is connected to the actuation element 130, which supplies electric current through the coils 705 of the actuation element 130. The symbol └ represents current flowing out of the page and a counter-clockwise magnetic field creating a north pole, and the symbol ⊗ represents current flowing into the page and a clockwise magnetic field creating a south pole. The amount of current flowing through the actuation element 130 is expressed as I(t)=I sin(ωt), where I is a mean current and I(t) is an instantaneous current at time t. By changing the current phase in the coils 705, the polarity of each coil 705 is changed. The attractive and repelling forces between the coils 705 in the actuation element 130 and the magnets of the interaction element 140 cause the frame 110 to move and generate a linear force 910. The speed/velocity of the motion produced by the linear force 910 is based on the rate of change of the current, and the amperage of the current determines the amount of force 910 that is generated. The speed of the motion can be varied by changing the input frequency using an adjustable frequency drive or controller. F(t)=I*L*B*sin(ωt) (or F(t)=I*L*B*sin(ωt+φ)) is the same as discussed previously with respect to FIG. 8, and the depicted arrow represents a direction of the frame 110 movement and/or force or thrust 910.

In other embodiments, the interaction element 140 may include a conductive material rather than permanent magnets. In these embodiments, electric current is induced in the conductor material of the interaction element 140 due to a magnetic field created by electric current flowing through the actuation element 130. This induces eddy currents in the interaction element 140 when placed in the magnetic field of the actuation element 130, which creates an opposing magnetic field in accordance with Lenz's law. The two opposing fields will repel each other, creating motion as the magnetic field sweeps through the interaction element 140. The induced current interacts with the traveling flux wave to produce linear force or thrust 910.

The combination of the various electromagnetic forces in FIGS. 8 and 9 provides phase offset modulation. Phase offset modulation works by overlaying two instances of a periodic waveform on top of each other, and multiplying the waveforms together or subtracting one waveform from the other waveform. The amount of offset (e.g., the difference between the two waveforms' starting points) dictates the duty cycle, and a variable offset amount creates pulse-width modulation. The phase offset modulation produced by the combined electromagnetic forces, and facilitated by the flexibility of the suspension elements 150, causes a closed-loop circular/elliptical trajectory of the diffuser element 100. In addition, the phase offset may be aligned with a self-resonance frequency of the diffuser device 20 to reduce power consumption of the actuation elements 130 (e.g., the electromagnetic drives).

Referring to FIG. 1-9, the diffuser device 20 operates as follows. The laser light source 11 generates laser light 12, which is projected by the projector unit 13 through the optical element 14 and onto the surface of the diffuser element 100 (which may correspond to diffuser screen 15 in FIG. 1) and then onto the imaging matrix 16. The frame 110 flexibly hangs on the suspension elements 150. A controller causes current pulses at a certain frequency to be sent from a power source to the actuation elements 130. The current flowing through the actuation elements 130 (e.g., including coils 705) results in magnetic force acting in the diffuser plane. The actuation elements 130 interact with the interaction elements 140, which causes the frame 110 with the diffuser element 100 to tilt or move in the direction of the magnetic force. The motion of the frame 110 is a closed-loop system, where the movement caused by a first actuation pair 130-140 influences the magnitude and direction of the motion of a second actuation pair 130-140, which then influences the magnitude and direction of the motion of a third actuation pair 130-140, and then feeds back to influence the magnitude and direction of the motion of the first actuation pair 130-140. Additionally, the movement of the frame 110 is enabled in part by the deformation of the flexible suspension elements 150 on which the frame 110 hangs. The speckle effect is reduced in the image plane and the projected image is smoothed for an observer's 75 eye on account of the continuous cyclic or reciprocating movement of each point on the diffuser element 100 surface. In these ways, the diffuser device 20 is able to achieve noiseless (or almost noiseless) operation and little to no mechanical wear through the absence of friction pairs in the diffuser device 20. Because the motion provided by the actuation pairs 130-140 is frictionless, the diffuser device 20 is not subject to mechanical wear as is the case with most conventional diffusers. Resistance to external vibration is also achieved by the resilient hanging of the suspension elements 150.

The diffuser device 20 may operate as a closed-loop control system, which is a control system where feedback is monitored and used to control the action the elements in the system in such a way as to tend to (or attempt to) reduce the deviation to zero. The control action (e.g., control signals, etc.) from the controller is dependent on feedback from the process in the form of a process variable (PV) value. For example, one or more sensors (e.g., sensors 1221 in FIG. 12) may be used to measure the speed/velocity of the circular motion 810 of the frame 110 and/or diffusion element 100, which is then compared with a speed/velocity set point (SP) or threshold. In this example, the controller generates and outputs control signals to maintain the speed/velocity at the desired speed/velocity by varying the amount of current supplied to the actuation elements 130 or by pulsing (e.g., switching on/off) the current supplied to the actuation elements 130. In another example, one or more sensors may be used to measure the current and/or voltage supplied to the actuation elements 130, which is then compared with a current/voltage SP or threshold current/voltage. In this example, the controller generates and outputs control signals to maintain the current/voltage at the desired current/voltage by controlling a switch to the power supply on and off. Other variables may be measured and other control mechanisms may be used in other embodiments.

FIG. 10 illustrates an example HUD system 1000 for a vehicle 1005 configured with multiple image planes, including a first image plane 1010, a second image plane 1020, and a third image plane 1030. In some examples, first image plane 1010 may be associated with a focal distance A, second image plane 1020 may be associated with a focal distance B, and third image plane 1020 may be associated with a focal distance that approximates infinity.

When vehicle 1005 is moving at relatively high speeds, such as on an uncongested highway at speeds above 40 mph, an image projection system 1050 may be configurable to display one or more computer-generated virtual graphics, e.g., images, text, or other types of imaging information, to a vehicle operator or observer 1075 on third image plane 1030. In some examples, third image plane 1030 may approximate a predetermined distance, e.g., a distance greater than twenty meters, from vehicle 1005. At relatively high speeds, observer 1075 may typically be looking down the road and scanning for objects that may be located at distances of greater than the predetermined distance of twenty meters. Accordingly, HUD system 1000 may be configurable to have the focal plane associated with the computer generated virtual graphics coincide with the relatively distant objects that are being viewed by observer 1075.

On the other hand, when the vehicle is moving at medium range speeds, such as when the observer 1075 drives vehicle 1005 on city streets or on congested highways at speeds above 20 mph but below 40 mph, HUD system 1000 may project virtual graphics on second image plane 1020 to coincide with objects that are located at focal distance B from vehicle 1005. In some examples, focal distance B associated with second image plane 1020 may be less than twenty meters, e.g., approximately ten meters.

When vehicle 1005 is moving at relatively slow speeds, such as when observer 1075 operates vehicle 1005 around a parking lot or accident scene at speeds below 20 mph, HUD system 1000 may be configurable to project virtual graphics at first image plane 1010 to coincide with objects that are located at focal distance A from vehicle 1005. In some examples, focal distance A associated with first image plane 1010 may be less than ten meters, e.g., approximately three to five meters.

FIG. 11 illustrates an example display system 1100 configurable to interface with an on-board operating system 1120. Referring to FIG. 11, on-board operating system 1120 may comprise one or more vehicle processors or on-board computers, memory of any known type, and instructions stored in the memory, that may interface with a HUD processor 1110. In an example embodiment, display system 1100 may be configurable to connect to the on-board operating system 1120 via the on-board diagnostic (OBD) port of vehicle 1005. HUD processor 1110 may be configurable to control or otherwise operate a projection device 1130 that, in turn, may be configurable to generate and/or project light representative of at least one virtual image onto an imaging matrix 1150 (e.g., which may be the same or similar to imaging matrix 16). HUD processor 1110 may determine virtual graphics to display on display device 1160 according to one or more HUD apps and provide indication of the virtual graphics to projection device 1130 that, in turn, may project light representative of the virtual graphic to the imaging matrix 1150. In some examples, one or more optical devices 1140 or lenses may be configurable to correct aberrations, filter, and/or to improve light utilization efficiencies. Optical devices 1140 may include any type of optical device (e.g., filters).

Imaging matrix 1150, in turn, may be configurable to selectively distribute and/or propagate the virtual image received as light from projection device 1130 or optical devices 1140 as one or more wave fronts to a display device 1160. In some examples, display device 1160 may comprise a vehicle windshield (e.g., screen 17 of FIG. 1), a holographic film placed adjacent windshield (e.g., holographic film 17a shown by FIG. 1), or a combination thereof.

In some examples, imaging matrix 1150 may comprise a holographic phase-amplitude modulator configurable to simulate an arbitrary wave front of light. In an example embodiment, imaging matrix 1150 may simulate a wave front for each of multiple image planes, each wave front representing a virtual image. Imaging matrix 1150 may be configurable to implement an arbitrary number of virtual image planes with information displayed on them simultaneously and arbitrarily.

Imaging matrix 1150 may comprise a high-resolution phase modulator, such as a full high-definition modulator having any suitable resolution (e.g., 4000 or higher pixel resolution). Imaging matrix 1150 may be illuminated by coherent light received from projection device 1130 or optical devices 1140 with a predefined beam divergence. Imaging matrix 1150 may produce a digital hologram on the modulator and may project a wave front representative of the hologram onto a display device 1160 on multiple simultaneous virtual image planes 1170.

Display system 1100 is configurable or operable to generate one or more virtual graphics on image plane 1170. In some examples, image plane 1170 may be associated with a focal distance 1175. Although image plane 1170 is illustrated as being located on an opposite side of display device 1160 from imaging matrix 1150, in some example embodiments, display device 1100 may be configurable to reflect light associated with the wave front propagated by imaging matrix 1150 so that the resulting image is reflected back to observer 1075. While the image may be reflected back from display device 1160 to observer 1075, the image plane may nevertheless appear to the observer 1075 to be located on the opposite side of the display device 1160 (e.g., on the same side of the display device as the real-world objects, outside of the vehicle).

Additionally, display system 1100 may comprise a translation device or motor 1180 configurable to dynamically vary the focal distance 1175 associated with image plane 1170. In some examples, motor 1180 may move imaging matrix 1150 relative to display device 1160 in any direction (e.g., vertical or horizontal), as well as change the incline angle of imaging device 1150. In other examples, motor 1180 may be configurable to move one or more optical devices 1140 relative to imaging matrix 1150. Still further, motor 1180 may be configurable to vary a focal distance 1145 between the one or more optical devices 1140 and imaging matrix 1150. Motor 1180 may dynamically vary the focal distance 1175 by moving imaging matrix 1150 relative to display device 1160 or relative to optical devices 1140 or by moving optical devices 1140 relative to imaging matrix 1150. In an example embodiment, motor 1180 may dynamically vary the focal distance 1175 according to HUD apps. The HUD apps may cause the motor 1180 to change the focal distance 1175 based on, for example, predetermined operational parameters including vehicle parameters (e.g., speed, location, travel direction, destination, windshield location, traffic, and the like), road parameters (e.g., location or presence of real world objects, roads, and the like), vehicle observer parameters (e.g., operator location within vehicle 1005, observer eye tracking, eye location, position of system, and the like), or a combination thereof. Operational parameters may further include any input received from any of a plurality of sources including vehicle systems or settings including, for example, sensor circuitry 1221, I/O devices 1286, actuators 1222, ECUs 1224, positioning circuitry 1245, or a combination thereof as shown by FIG. 12. In addition to varying the focal distance 1175 of image plane 1170, motor 1180 may be configurable to adjust the relative distance of image plane to observer 1075. In an example embodiment, display system 1100 may be configurable to be compatible with a number of different types of vehicles which may be associated with different operator positions, including height of the operator's eyes or distance from the operator to windshield (e.g., screen 17 shown by FIG. 1).

Although not shown by FIG. 11, in various embodiments, display system 1100 may include multiple projection devices 1130, optical devices 1140 imaging matrices 1150, display devices 1160, and motors 1180 that may be disposed in a multitude of arrangements.

FIG. 12 illustrates an example computing system 1200, in accordance with various embodiments. The system 1200 may include any combinations of the components as shown, which may be implemented as integrated circuits (ICs) or portions thereof, discrete electronic devices, or other modules, logic, hardware, software, firmware, middleware or a combination thereof adapted in the system 1200, or as components otherwise incorporated within a chassis of a larger system, such as a vehicle and/or HUD system. Additionally or alternatively, some or all of the components of system 1200 may be combined and implemented as a suitable System-on-Chip (SoC), System-in-Package (SiP), multi-chip package (MCP), or some other like package. The system 1200 is an embedded system or any other type of computer device discussed herein. In another example, the system 1200 may be a separate and dedicated and/or special-purpose computer device designed specifically to carry out holographic HUD solutions of the embodiments discussed herein.

The processor circuitry 1202 comprises one or more processing elements/devices configurable to perform basic arithmetical, logical, and input/output operations by carrying out and/or executing instructions. According to various embodiments, processor circuitry 1202 is configurable to perform some or all of the calculations associated with the preparation and/or generation of virtual graphics and/or other types of information that are to be projected by HUD system 1000 for display, in real time. Additionally, processor circuitry 1202 is configurable to gather information from sensor circuitry 1221 (e.g., process a video feed from a camera system or image capture devices), obtain user input from one or more I/O devices 1286, and obtain vehicle input 950 substantially in real time. Some or all of the inputs may be received and/or transmitted via communication circuitry 1209. In order to perform the aforementioned functions, the processor circuitry 1202 may execute instructions 1280, and/or may be loaded with an appropriate bit stream or logic blocks to generate virtual graphics based, at least in part, on any number of parameters, including, for example, input from sensor circuitry 1221, input from I/O devices 1286, input from actuators 1222, input from ECUs 1224, input from positioning circuitry 1245, and/or the like. Additionally, processor circuitry 1202 may be configurable to receive audio input, or to output audio, over an audio device 1221. For example, processor circuitry 1202 may be configurable to provide signals/commands to an audio output device 1286 to provide audible instructions to accompany the displayed navigational route information or to provide audible alerts.

The processor circuitry 1202 includes circuitry such as, but not limited to one or more processor cores and one or more of cache memory, low drop-out voltage regulators (LDOs), interrupt controllers, serial interfaces such as serial peripheral interface (SPI), inter-integrated circuit (I2C) or universal programmable serial interface circuit, real time clock (RTC), timer-counters including interval and watchdog timers, general purpose input-output (I/O), memory card controllers, interconnect (IX) controllers and/or interfaces, universal serial bus (USB) interfaces, mobile industry processor interface (MIPI) interfaces, Joint Test Access Group (JTAG) test access ports, and the like. The processor circuitry 1202 may include on-chip memory circuitry or cache memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of processor circuitry 1202 may be, for example, one or more application processors or central processing units (CPUs), one or more graphics processing units (GPUs), one or more reduced instruction set computing (RISC) processors, one or more Acorn RISC Machine (ARM) processors, one or more complex instruction set computing (CISC) processors, one or more DSPs, one or more microprocessor without interlocked pipeline stages (MIPS), one or more programmable logic devices (PLDs) and/or hardware accelerators) such as field-programmable gate arrays (FPGAs), structured/programmable Application Specific Integrated Circuit (ASIC), programmable SoCs (PSoCs), etc., one or more microprocessors or controllers, or any suitable combination thereof. In some embodiments, the processor circuitry 1202 may be implemented as a standalone system/device/package or as part of an existing system/device/package (e.g., an ECU/ECM, EEMS, etc.) of the vehicle 1005. In some embodiments, the processor circuitry 1202 may include special-purpose processor/controller to operate according to the various embodiments herein.

Individual processors (or individual processor cores) of the processor circuitry 1202 may be coupled with or may include memory/storage and may be configurable to execute instructions stored in the memory/storage to enable various applications or operating systems to run on the system 1200. In these embodiments, one or more processors (or cores) of the processor circuitry 1202 may correspond to the processor 312 of FIG. 11 and is/are configurable to operate application software (e.g., HUD app) to provide specific services to a user of the system 1200. In some embodiments, one or more processors (or cores) of the processor circuitry 1202, such as one or more GPUs or GPU cores, may correspond to the HUD processor 1110 and is/are configurable to generate and render graphics as discussed previously.

As examples, the processor circuitry 1202 may include an Intel® Architecture Core™ based processor, such as a Quark™, an Atom™, an i3, an i5, an i7, or an MCU-class processor, Pentium® processor(s), Xeon® processor(s), or another such processor available from Intel® Corporation, Santa Clara, Calif. However, any number other processors may be used, such as one or more of Advanced Micro Devices (AMD) Zen® Core Architecture, such as Ryzen® or

EPYC® processor(s), Accelerated Processing Units (APUs), MxGPUs, Epyc® processor(s), or the like; A5-A12 and/or S1-S4 processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. Other examples of the processor circuitry 1202 are mentioned elsewhere in the present disclosure.

In some implementations, the processor circuitry 1202 may include a sensor hub, which acts as a coprocessor by processing data obtained from the sensor circuitry 1221. The sensor hub may include circuitry configurable to integrate data obtained from each of the sensor circuitry 1221 by performing arithmetical, logical, and input/output operations. In embodiments, the sensor hub may capable of time stamping obtained sensor data, providing sensor data to the processor circuitry 1202 in response to a query for such data, buffering sensor data, continuously streaming sensor data to the processor circuitry 1202 including independent streams for each sensor circuitry 1221, reporting sensor data based upon predefined thresholds or conditions/triggers, and/or other like data processing functions.

The memory circuitry 1204 comprises any number of memory devices arranged to provide primary storage from which the processor circuitry 1202 continuously reads instructions 1382 stored therein for execution. In some embodiments, the memory circuitry 1204 includes on-die memory or registers associated with the processor circuitry 1202. As examples, the memory circuitry 1204 may include volatile memory such as random access memory (RAM), static RAM (SRAM), dynamic RAM (DRAM), synchronous DRAM (SDRAM), etc. The memory circuitry 1204 may also include non-volatile memory (NVM) such as read-only memory (ROM), high-speed electrically erasable memory (commonly referred to as “flash memory”), and non-volatile RAM such as phase change memory, resistive memory such as magnetoresistive random access memory (MRAM), etc.

In some implementations, the processor circuitry 1202 and memory circuitry 1204 (and/or storage device 1208) may comprise logic blocks or logic fabric, memory cells, input/output (I/O) blocks, and other interconnected resources that may be programmed to perform various functions of the example embodiments discussed herein. The memory cells may be used to store data in lookup-tables (LUTs) that are used by the processor circuitry 1202 to implement various logic functions. The memory cells may include any combination of various levels of memory/storage including, but not limited to, EPROM, EEPROM, flash memory, SRAM, anti-fuses, etc. The memory circuitry 1204 may also comprise persistent storage devices, which may be temporal and/or persistent storage of any type, including, but not limited to, non-volatile memory, optical, magnetic, and/or solid state mass storage, and so forth.

Storage circuitry 1208 is arranged to provide (with shared or respective controllers) persistent storage of information such as data, applications, operating systems, and so forth. As examples, the storage circuitry 1208 may be implemented as hard disk drive (HDD), a micro HDD, a solid-state disk drive (SSDD), flash memory, flash memory cards (e.g., SD cards, microSD cards, xD picture cards, and the like), USB flash drives, resistance change memories, phase change memories, holographic memories, or chemical memories, and the like. In an example, the storage circuitry 1208 may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory. As shown, the storage circuitry 1208 is included in the system 1200; however, in other embodiments, storage circuitry 1208 may be implemented as one or more separate devices that are mounted in vehicle 1005 separate from the other elements of system 1200.

The storage circuitry 1208 is configurable to store computational logic 1283 (or “modules 1283”) in the form of software, firmware, microcode, or hardware-level instructions to implement the techniques described herein. The computational logic 1283 may be employed to store working copies and/or permanent copies of programming instructions for the operation of various components of system 1200 (e.g., drivers, libraries, application programming interfaces (APIs), etc.), an OS of system 1200, one or more applications, and/or for carrying out the embodiments discussed herein. According to various embodiments, the computational logic 1283 may include one or more HUD apps discussed previously. The permanent copy of the programming instructions may be placed into persistent storage devices of storage circuitry 1208 in the factory or in the field through, for example, a distribution medium (not shown), through a communication interface (e.g., from a distribution server (not shown)), or over-the-air (OTA). The computational logic 1283 may be stored or loaded into memory circuitry 1204 as instructions 1282, which are then accessed for execution by the processor circuitry 1202 to carry out the functions described herein. The instructions 1282 direct the processor circuitry 1202 to perform a specific sequence or flow of actions, for example, as described with respect to the flowchart(s) and block diagram(s) of operations and functionality depicted herein. The modules/logic 1283 and/or instructions 1280 may be implemented by assembler instructions supported by processor circuitry 1202 or high-level languages that may be compiled into instructions 1280 to be executed by the processor circuitry 1202.

The computer program code for carrying out operations of the present disclosure (e.g., computational logic 1283, instructions 1282, 1280, etc.) may be written in any combination of one or more programming languages, including an object oriented programming language such as Python, Ruby, Scala, Smalltalk, Java™, C++, C#, or the like; a procedural programming languages, such as the “C” programming language, the Go (or “Golang”) programming language, or the like; a scripting language such as JavaScript, Server-Side JavaScript (SSJS), PHP, Pearl, Python, Ruby or Ruby on Rails, Accelerated Mobile Pages Script (AMPscript), VBScript, and/or the like; a markup language such as HTML, XML, wiki markup or Wikitext, Wireless Markup Language (WML), etc.; a data interchange format/definition such as Java Script Object Notion (JSON), Apache® MessagePack™, etc.; a stylesheet language such as Cascading Stylesheets (CSS), extensible stylesheet language (XSL), or the like; an interface definition language (IDL) such as Apache® Thrift, Abstract Syntax Notation One (ASN.1), Google® Protocol Buffers (protobuf), etc.; or some other suitable programming languages including proprietary programming languages and/or development tools, or any other languages or tools as discussed herein. The computer program code for carrying out operations of the present disclosure may also be written in any combination of the programming languages discussed herein. The program code may execute entirely on the system 1200, partly on the system 1200 as a stand-alone software package, partly on the system 1200 and partly on a remote computer, or entirely on the remote computer. In the latter scenario, the remote computer may be connected to the system 1200 through any type of network (e.g., network 1220).

The OS of system 1200 manages computer hardware and software resources, and provides common services for various applications (e.g., application 110). The OS of system 1200 may be or include the on-board operating system 1120 discussed previously. The OS may include one or more drivers or APIs that operate to control particular devices that are embedded in the system 1200, attached to the system 1200, or otherwise communicatively coupled with the system 1200. The drivers may include individual drivers allowing other components of the system 1200 to interact or control various I/O devices that may be present within, or connected to, the system 1200. For example, the drivers may include a display driver (or HUD system driver) to control and allow access to the HUD system 1000, a touchscreen driver to control and allow access to a touchscreen interface of the system 1200, sensor drivers to obtain sensor readings of sensor circuitry 1321 and control and allow access to sensor circuitry 1321, actuator drivers to obtain actuator positions of the actuators 1322 and/or control and allow access to the actuators 1222, ECU drivers to obtain control system information from one or more of the ECUs 1224, audio drivers to control and allow access to one or more audio devices. The OSs may also include one or more libraries, drivers, APIs, firmware, middleware, software glue, etc., which provide program code and/or software components for one or more applications to obtain and use the data from other applications operated by the system 1200.

In some embodiments, the OS may be a general purpose OS, while in other embodiments, the OS is specifically written for and tailored to the system 1200. For example, the OS may be Unix or a Unix-like OS such as Linux e.g., provided by Red Hat Enterprise, Windows 10™ provided by Microsoft Corp.®, macOS provided by Apple Inc.®, or the like. In another example, the OS may be a mobile OS, such as Android® provided by Google iOS® provided by Apple Inc.®, Windows 10 Mobile® provided by Microsoft Corp.®, KaiOS provided by KaiOS Technologies Inc., or the like. In another example, the OS may be an embedded OS or a real-time OS (RTOS), such as Windows Embedded Automotive provided by Microsoft Corp.®, Windows 10 For IoTO provided by Microsoft Corp.®, Apache Mynewt provided by the Apache Software Foundation®, Micro-Controller Operating Systems (“MicroC/OS” or “μC/OS”) provided by Micrium®, Inc., FreeRTOS, VxWorks® provided by Wind River Systems, Inc.®, PikeOS provided by Sysgo AGO, Android Things® provided by Google QNXO RTOS provided by BlackBerry Ltd., or any other suitable embedded OS or RTOS, such as those discussed herein. In another example, the OS may be a robotics middleware framework, such as Robot Operating System (ROS), Robotics Technology (RT)-middleware provided by Object Management Group®, Yet Another Robot Platform (YARP), and/or the like.

In embodiments where the processor circuitry 1202 and memory circuitry 1204 includes hardware accelerators in addition to or alternative to processor cores, the hardware accelerators may be pre-configured (e.g., with appropriate bit streams, logic blocks/fabric, etc.) with the logic to perform some functions of the embodiments herein (in lieu of employment of programming instructions to be executed by the processor core(s)).

The components of system 1200 and/or vehicle 1005 communicate with one another over an interconnect (IX) 1206. In various embodiments, IX 1206 is a controller area network (CAN) bus system, a Time-Trigger Protocol (TTP) system, or a FlexRay system, which may allow various devices (e.g., ECUs 1224, sensor circuitry 1221, actuators 1222, etc.) to communicate with one another using messages or frames. Additionally or alternatively, the IX 1206 may include any number of other IX technologies, such as a Local Interconnect Network (LIN), industry standard architecture (ISA), extended ISA (EISA), inter-integrated circuit (I2C), a serial peripheral interface (SPI), point-to-point interfaces, power management bus (PMBus), peripheral component interconnect (PCI), PCI express (PCIe), Ultra Path Interface (UPI), Accelerator Link (IAL), Common Application Programming Interface (CAPI), QuickPath Interconnect (QPI), Omni-Path Architecture (OPA) IX, RapidIO™ system interconnects, Ethernet, Cache Coherent Interconnect for Accelerators (CCIA), Gen-Z Consortium IXs, Open Coherent Accelerator Processor Interface (OpenCAPI), and/or any number of other IX technologies. The IX 1306 may be a proprietary bus, for example, used in a SoC based system.

The communication circuitry 1209 is a hardware element, or collection of hardware elements, used to communicate over one or more networks (e.g., network 101) and/or with other devices. The communication circuitry 1209 includes modem 1210 and transceiver circuitry (“TRx”) 1212. The modem 1210 includes one or more processing devices (e.g., baseband processors) to carry out various protocol and radio control functions. Modem 1210 interfaces with application circuitry of system 1200 (e.g., a combination of processor circuitry 1202 and CRM 1360) for generation and processing of baseband signals and for controlling operations of the TRx 1212. The modem 1210 handles various radio control functions that enable communication with one or more radio networks via the TRx 1212 according to one or more wireless communication protocols, such as those discussed herein. The modem 1210 may include circuitry such as, but not limited to, one or more single-core or multi-core processors (e.g., one or more baseband processors) or control logic to process baseband signals received from a receive signal path of the TRx 1212, and to generate baseband signals to be provided to the TRx 1212 via a transmit signal path. In various embodiments, the modem 1210 may implement a real-time OS (RTOS) to manage resources of the modem 1210, schedule tasks, etc.

The communication circuitry 1209 also includes TRx 1212 to enable communication with wireless networks using modulated electromagnetic radiation through a non-solid medium. TRx 1212 includes a receive signal path, which comprises circuitry to convert analog RF signals (e.g., an existing or received modulated waveform) into digital baseband signals to be provided to the modem 1210. The TRx 1212 also includes a transmit signal path, which comprises circuitry configurable to convert digital baseband signals provided by the modem 1210 to be converted into analog RF signals (e.g., modulated waveform) that will be amplified and transmitted via an antenna array including one or more antenna elements (not shown). The antenna array is coupled with the TRx 1212 using metal transmission lines or the like. The antenna array may be a one or more microstrip antennas or printed antennas that are fabricated on the surface of one or more printed circuit boards; a patch antenna array formed as a patch of metal foil in a variety of shapes; a glass-mounted antenna array or “on-glass” antennas; or some other known antenna or antenna elements.

The TRx 1212 may include one or more radios that are compatible with, and/or may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a 3GPP radio communication technology such as Universal Mobile Telecommunications System (UMTS), Freedom of Multimedia Access (FOMA), Code Division Multiple Access 2000 (CDM2000), Cellular Digital Packet Data (CDPD), Mobitex, Circuit Switched Data (CSD), High-Speed Circuit-Switched Data (HSCSD), UMTS Wideband Code Division Multiple Access, High Speed Packet Access (HSPA), High-Speed Downlink Packet Access (HSDPA), High-Speed Uplink Packet Access (HSUPA), High Speed Packet Access Plus (HSPA+), UMTS-Time-Division Duplex (UMTS-TDD), Time Division-Code Division Multiple Access (TD-CDMA), Time Division-Synchronous Code Division Multiple Access (TD-CDMA), Long Term Evolution (LTE), LTE-Advanced (LTE-A), LTE Extra, LTE-A Pro, LTE Licensed-Assisted Access (LAA), MuLTEfire, UMTS Terrestrial Radio Access (UTRA), Evolved UMTS Terrestrial Radio Access (E-UTRA), Fifth Generation (5G) or New Radio (NR), 3GPP device-to-device (D2D) or Proximity Services (ProSe), 3GPP cellular vehicle-to-everything (V2X), Evolution-Data Optimized or Evolution-Data Only (EV-DO), Advanced Mobile Phone System (AMPS), Total Access Communication System/Extended Total Access Communication System (TACS/ETACS), Digital AMPS (D-AMPS), Push-to-talk (PTT), Mobile Telephone System (MTS), Improved Mobile Telephone System (IMTS), Advanced Mobile Telephone System (AMTS), Offentlig Landmobil Telefoni (OLT) which is Norwegian for Public Land Mobile Telephony, Mobiltelefonisystem D (MTD) which is Swedish for Mobile telephony system D, Public Automated Land Mobile (Autotel/PALM), Autoradiopuhelin (ARP) which is Finnish for “car radio phone”, Nordic Mobile Telephony (NMT), Nippon Telegraph and Telephone (NTT), High capacity (Hicap) version of NTT, Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA) also referred to as also referred to as 3GPP Generic Access Network (GAN), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, I600.11a, etc.) WiFi-direct, ANT/ANT+, ZigBee, Z-Wave, Universal Plug and Play (UPnP), Low-Power Wide-Area-Network (LPWAN), LoRaWAN™ (Long Range Wide Area Network), Sigfox, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other), Dedicated Short Range Communications (DSRC) communication systems such as Intelligent-Transport-Systems and others, the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), etc.. In addition to the aforementioned standards, any number of satellite uplink technologies may be used for the TRx 1212 including, for example, radios compliant with standards issued by the International Telecommunication Union (ITU), or the European Telecommunications Standards Institute (ETSI), among others, both existing and not yet formulated.

Network interface circuitry/controller (NIC) 1216 may be included to provide wired communication to the network 101 or to other devices using a standard network interface protocol. In most cases, the NIC 1216 may be used to transfer data over a network (e.g., network XA20) via a wired connection while the vehicle is stationary (e.g., in a garage, testing facility, or the like). The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the system 1200 via NIC 1216 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The NIC 1216 may include one or more dedicated processors and/or FPGAs to communicate using one or more of the aforementioned network interface protocols. In some implementations, the NIC 1216 may include multiple controllers to provide connectivity to other networks using the same or different protocols. For example, the system 1200 may include a first NIC 1216 providing communications to the cloud over Ethernet and a second NIC 1216 providing communications to other devices over another type of network.

The input/output (I/O) interface 1218 is configurable to connect or coupled the system 1200 with external devices or subsystems. The external interface 1318 may include any suitable interface controllers and connectors to couple the system 1200 with the external components/devices, such as an external expansion bus (e.g., Universal Serial Bus (USB), FireWire, PCIe, Thunderbolt, etc.), used to connect system 1200 with external components/devices, such as sensor circuitry 1221, actuators 1222, electronic control units (ECUs) 1224, positioning system 1245, input device(s) 1286, and picture generation units (PGUs) 1230. In some cases, the I/O interface circuitry 1218 may be used to transfer data between the system 1200 and another computer device (e.g., a laptop, a smartphone, or some other user device) via a wired connection. I/O interface circuitry 1218 may include any suitable interface controllers and connectors to interconnect one or more of the processor circuitry 1202, memory circuitry 1204, storage circuitry 1208, communication circuitry 1209, and the other components of system 1200. The interface controllers may include, but are not limited to, memory controllers, storage controllers (e.g., redundant array of independent disk (RAID) controllers, baseboard management controllers (BMCs), input/output controllers, host controllers, etc. The connectors may include, for example, busses (e.g., IX 1206), ports, slots, jumpers, interconnect modules, receptacles, modular connectors, etc. The I/O interface circuitry 1218 may also include peripheral component interfaces including, but are not limited to, non-volatile memory ports, USB ports, audio jacks, power supply interfaces, on-board diagnostic (OBD) ports, etc.

The sensor circuitry 1321 includes devices, modules, or subsystems whose purpose is to detect events or changes in its environment and send the information (sensor data) about the detected events to some other a device, module, subsystem, etc. Examples of such sensors 1221 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

Some of the sensor circuitry 1221 may be sensors used for various vehicle control systems, and may include, inter alia, exhaust sensors including exhaust oxygen sensors to obtain oxygen data and manifold absolute pressure (MAP) sensors to obtain manifold pressure data; mass air flow (MAF) sensors to obtain intake air flow data; intake air temperature (IAT) sensors to obtain IAT data; ambient air temperature (AAT) sensors to obtain AAT data; ambient air pressure (AAP) sensors to obtain AAP data; catalytic converter sensors including catalytic converter temperature (CCT) to obtain CCT data and catalytic converter oxygen (CCO) sensors to obtain CCO data; vehicle speed sensors (VSS) to obtain VSS data; exhaust gas recirculation (EGR) sensors including EGR pressure sensors to obtain ERG pressure data and EGR position sensors to obtain position/orientation data of an EGR valve pintle; Throttle Position Sensor (TPS) to obtain throttle position/orientation/angle data; a crank/cam position sensors to obtain crank/cam/piston position/orientation/angle data; coolant temperature sensors; and/or other like sensors embedded in vehicles 1005. The sensor circuitry 1221 may include other sensors such as an accelerator pedal position sensor (APP), accelerometers, magnetometers, level sensors, flow/fluid sensors, barometric pressure sensors, and the like.

The positioning circuitry 1245 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 1245 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 1245 may include a Micro-Technology for Positioning, Navigation, and Timing (Micro-PNT) IC that uses a master timing clock to perform position tracking/estimation without GNSS assistance. The positioning circuitry 1245 may also be part of, or interact with, the communication circuitry 1209 to communicate with the nodes and components of the positioning network. The positioning circuitry 1245 may also provide position data and/or time data to the application circuitry, which may use the data to synchronize operations with various infrastructure (e.g., radio base stations), for turn-by-turn navigation, or the like. Additionally or alternatively, the positioning circuitry 1245 may be incorporated in, or work in conjunction with the communication circuitry to determine the position or location of the vehicle 1005 by, for example, implementing the LTE Positioning Protocol (LPP), Wi-Fi positioning system (WiPS or WPS) methods, triangulation, signal strength calculations, and/or some other suitable localization technique(s).

In some embodiments, sensor circuitry 1221 may be used to corroborate and/or refine information provided by positioning circuitry 1245. In a first example, input from a camera 1221 may be used by the processor circuitry 1202 (or a HUD app operated by the processor circuitry 1202) to measure the relative movement of an object/image and to calculate the vehicle movement speed and turn speed to calibrate or improve the precision of a position sensor 1221/1245. In a second example, input from a barometer may be used in conjunction with the positioning circuitry 1245 (or a HUD app operated by the processor circuitry 1202) to more accurately determine the relative altitude of the vehicle 1005, and determine the position of the vehicle 1005 relative to a mapped coordinate system. In a third example, images or video captured by a camera 1221 or image aperture device 1221 may be used in conjunction with the positioning circuitry 1245 (or a HUD app operated by the processor circuitry 1202) to more accurately determine the relative distance between the vehicle 1005 and particular feature or landmark associated with the mapped coordinate system, such as a turn or a destination. In a fourth example, input from an inertial sensor 1221 may be used by the processor circuitry 1202 (or a HUD app operated by the processor circuitry 1202) to calculate and/or determine vehicle speed, turn speed, and/or position of the vehicle XA00. In a fourth example, processor circuitry 1202 (or a HUD app operated by the processor circuitry 1202) may be configurable to locate and/or identify a vehicle operator by a user recognition device/system, which may comprise a camera 1221 or tracking device 1221 configurable to identify the operator and/or to locate the operator's relative position and/or height relative to a display device (e.g., an HOE 1231 discussed infra). Based on information received from user input and/or user recognition device/system, processor circuitry 1202 (or a HUD app operated by the processor circuitry 1202) may be configurable to initialize, customize, adjust, calibrate, or otherwise modify the functionality of system 1200 to accommodate a particular user.

Individual ECUs 1224 may be embedded systems or other like computer devices that control a corresponding system of the vehicle 1005. In embodiments, individual ECUs 1224 may each have the same or similar components as the system 1200, such as a microcontroller or other like processor device, memory device(s), communications interfaces, and the like. In embodiments, the ECUs 1224 may include, inter alia, a Drivetrain Control Unit (DCU), an Engine Control Unit (ECU), an Engine Control Module (ECM), EEMS, a Powertrain Control Module (PCM), a Transmission Control Module (TCM), a Brake Control Module (BCM) including an anti-lock brake system (ABS) module and/or an electronic stability control (ESC) system, a Central Control Module (CCM), a Central Timing Module (CTM), a General Electronic Module (GEM), a Body Control Module (BCM), a Suspension Control Module (SCM), a Door Control Unit (DCU), a Speed Control Unit (SCU), a Human-Machine Interface (HMI) unit, a Telematic Control Unit (TTU), a Battery Management System (which may be the same or similar as battery monitor 1226) and/or any other entity or node in a vehicle system. In some embodiments, the one or more of the ECUs 1224 and/or system 1200 may be part of or included in a Portable Emissions Measurement Systems (PEMS).

The actuators 1222 are devices that allow system 1200 to change a state, position, orientation, move, and/or control a mechanism or system in the vehicle 1005. The actuators 1222 comprise electrical and/or mechanical devices for moving or controlling a mechanism or system, and converts energy (e.g., electric current or moving air and/or liquid) into some kind of motion. The actuators 1222 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 1222 may include one or more electromechanical devices such as pneumatic actuators, hydraulic actuators, electromechanical switches including electromechanical relays (EMRs), motors (e.g., linear motors, DC motors, brushless motors, stepper motors, servomechanisms, ultrasonic piezo motor with optional position feedback, screw-type motors, etc.), mechanical gears, magnetic switches, valve actuators, fuel injectors, ignition coils, wheels, thrusters, propellers, claws, clamps, hooks, an audible sound generator, and/or other like electromechanical components. As examples, the translation device or motor 1180 discussed previously may be among the one or more of the actuators 1222. The system 1200 may be configurable to operate one or more actuators 1222 based on one or more captured events and/or instructions or control signals received from various ECUs 1224 or system 1200. In embodiments, the system 1200 may transmit instructions to various actuators 1222 (or controllers that control one or more actuators 1222) to reconfigure an electrical network as discussed herein. In embodiments, system 1200 and/or ECUs 1224 are configurable to operate one or more actuators 1222 by transmitting/sending instructions or control signals to one or more actuators 1222 based on detected events. Individual ECUs 1224 may be capable of reading or otherwise obtaining sensor data from the sensor circuitry 1221, processing the sensor data to generate control system data, and providing the control system data to the system 1200 for processing. The control system information may be a type of state information discussed previously. For example, an ECU 1224 may provide engine revolutions per minute (RPM) of an engine of the vehicle 1005, fuel injector activation timing data of one or more cylinders and/or one or more injectors of the engine, ignition spark timing data of the one or more cylinders (e.g., an indication of spark events relative to crank angle of the one or more cylinders), transmission gear ratio data and/or transmission state data (which may be supplied to the ECU 1224 by the TCU), real-time calculated engine load values from the ECM, etc.; a TCU may provide transmission gear ratio data, transmission state data, etc.; and the like.

The I/O devices 1386 may be present within, or connected to, the system 1200. The I/O devices 1286 include input devices and output devices including one or more user interfaces designed to enable user interaction with the system 1200 and/or peripheral component interaction with the system 1200 via peripheral component interfaces. The input devices include any physical or virtual means for accepting an input including, inter alia, one or more physical or virtual buttons (e.g., a reset button), a physical keyboard, keypad, mouse, touchpad, touchscreen, microphones, scanner, headset, and/or the like. It should be noted that user input may comprise voice commands, control input (e.g., via buttons, knobs, switches, etc.), an interface with a smartphone, or any combination thereof.

The output devices are used to show or convey information, such as sensor readings, actuator position(s), or other like information. Data and/or graphics may be displayed on one or more user interface components of the output devices. The output devices may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the system 1200. The output devices may also include speakers or other audio emitting devices, printer(s), and/or the like. In some embodiments, the output devices include the HUD system 1000 in addition to the aforementioned output devices. In some embodiments, the sensor circuitry 1221 may be used as an input device (e.g., an image capture device, motion capture device, or the like) and one or more actuators 1222 may be used as an output device (e.g., an actuator to provide haptic feedback or the like). In another example, near-field communication (NFC) circuitry comprising an NFC controller coupled with an antenna element and a processing device may be included as an input device to read electronic tags and/or connect with another NFC-enabled device.

As alluded to previously, the HUD system 1000 is also included in the vehicle 1005. In this example, the HUD system 1000 comprises one or more PGUs 1230, one or more optical elements (e.g., lenses, filters, beam splitters, diffraction gratings, etc.), and one or more combiner elements (or “combiners”). Optical elements that are used to produce holographic images may be referred to as holographic optical elements (HOEs) 1231.

Each of the PGUs 1230 include a projection unit (or “projector”) and a computer device. The projector may be the projection device 1130 discussed previously. The computer device comprises one or more electronic elements that create/generate digital content to be displayed by the projection unit. The computer device may be the processor circuitry 1202, HUD processor 1110, or a similar processing device as discussed previously. The digital content (e.g., text, images, video, etc.) may be any type of content stored by the storage circuitry 1208, streamed from backend system XA30 and/or remote devices via the communication circuitry 1209, and/or based on outputs from various sensors 1220, ECUs 1224, and/or actuators 1222. The content to be displayed may include, for example, safety messages (e.g., collision warnings, emergency warnings, pre-crash warnings, traffic warnings, and the like), Short Message Service (SMS)/Multimedia Messaging Service (MMS) messages, navigation system information (e.g., maps, turn-by-turn indicator arrows), movies, television shows, video game images, and the like.

The projection unit (or “projector”) is a device or system that projects still or moving images onto the surface(s) of HOEs 1231 via one or more reflection surfaces (e.g., mirrors) based on signals received from the computer device. The projection unit may include a light generator (or light source) to generate light based on the digital content, which is focused or (re)directed to one or more HOEs (e.g., display surface(s)). The projection unit may include various electronic elements (or an electronic system) that convert the digital content, or signals obtained from the computer device, into signals for controlling the light source to generate/output light of different colors and intensities. In embodiments, the projection unit is or includes the imaging matrix 1150 discussed previously. As examples, a projector of each PGU may be a light emitting diode (LED) projector, a laser diode projector, a liquid crystal display (LCD) projector, a digital light processing (DLP) projector, a digital micro-mirror device (DMD), a microelectromechanical (MEMS) laser scanner, a liquid crystal on silicon (LCoS) matrix/projector, and/or any other like projection device, including those discussed elsewhere herein.

In some implementations, the projection unit may include a collimator (e.g., a one or more lenses, apertures, etc.) to change diverging light from the light source into a parallel beam. In some implementations, the projector may include a combiner (also referred to as “combiner optic” and the like), which may combine different light paths into one light path to define a palette of colors. In some embodiments, the projection unit may comprise scanning mirrors that copy the image pixel-by-pixel and then project the image for display.

In some embodiments, the HUD system 1000 or the PGUs 1230 may comprise a relay lens assembly and a combiner element (which may be different than the combiner used for displaying the projected image). The relay lens assembly may comprise one or more relay lenses, which re-image images from the projector into an intermediate image that then reaches an HOE 1231 (e.g., the combiner element) through a reflector.

The generated light may be combined or overlapped with external (e.g., natural) light that is also (re)directed to the same HOE 1231. The HOE 1231 that combines the generated light with the external light may be referred to as a “combiner element” or “combiner.” The combiner may be a beam splitter or semi-transparent display surface located directly in front of the viewer (e.g., operator of vehicle 1005), that redirects the projected image from projector in such a way as to see the field of view and the projected image at the same time. In addition to reflecting the projected light from the projector unit, the combiner element also allows other wavelengths of light to pass through the combiner. In this way, the combiner element (as well as other HOEs 1231) mixes the digital images output by the projector with a viewed real-world to facilitate augmented reality.

The combiner may be formed or made of one or more a pieces of glass, plastic, or other similar material, and may have a coating that enables the combiner to reflect the projected light while allowing external (natural) light to pass through the combiner. In embodiments, the combiner element may be a windshield of the vehicle 1005, a separate semi-reflective surface mounted to a dashboard of the vehicle 1005, a switchable projection screen that switches between high contrast mode (e.g., a frosted or matte) and a transparent (e.g., holographic) mode, or the like. The combiner may have a flat surface or a curved surface (e.g., concave or convex) to aid in focusing the projected image. One or more of the HOEs 1231 may be transmissive optical elements, where the transmitted beam (reference beam) hits the HOE 1231 and the diffracted beam(s) go through the HOE 1231. One or more HOEs 1231 may be reflective optical elements, where the transmitted beam (reference beam) hits the HOE 1231 and the diffracted beam(s) reflects off of the HOE 1231 (e.g., the reference beam and diffracted beams are on the same side of the HOE 1231).

Additionally, one or more of the HOEs 1231 may use waveguide holographic techniques to progressively extract a collimated image guided by total internal reflection (TIR) in a waveguide pipe. The waveguide pipe may be a thin sheet of glass or plastic through which the generated light bounces to route the generated light to the viewer/user. In some embodiments, the HOEs 1231 may utilize holographic diffraction grating (e.g., Bragg diffraction grating) to provide the generated light to the waveguide at a critical angle, which travels through the waveguide. The light is steered toward the user/viewer by one or more other HOEs 1231 that utilize holographic diffraction grating. These HOEs 1231 may comprise grooved reflection gratings and/or a plurality of layers of alternating refraction indexes (e.g., comprising liquid crystals, photoresist substrate, etc.); the grooved reflection gratings and/or the refractive index layers may provide constructive and destructive interference and wavelet dispersion.

The battery 1228 may power the system 1200. In embodiments, the battery 1228 may be a typical lead-acid automotive battery, although in some embodiments, such as when vehicle 1005 is a hybrid vehicle, the battery 1228 may be a lithium ion battery, a metal-air battery, such as a zinc-air battery, an aluminum-air battery, a lithium-air battery, a lithium polymer battery, and the like. The battery monitor 1226 may be included in the system 1200 to track/monitor various parameters of the battery 1228, such as a state of charge (SoCh) of the battery 1228, state of health (SoH), and the state of function (SoF) of the battery 1228. The battery monitor 1226 may include a battery monitoring IC, which may communicate battery information to the processor circuitry 1202 over the IX 1206.

While not shown, various other devices may be present within, or connected to, the system 1200. For example, I/O devices, such as a display, a touchscreen, or keypad may be connected to the system 1200 via IX 1206 to accept input and display outputs. In another example, GNSS and/or GPS circuitry and associated applications may be included in or connected with system 1200 to determine a geolocation of the vehicle 1005. In another example, the communication circuitry 1205 may include a Universal Integrated Circuit Card (UICC), embedded UICC (eUICC), and/or other elements/components that may be used to communicate over one or more wireless networks.

Some non-limiting example as provided infra. The following examples pertain to further embodiments. Specifics in the examples may be used anywhere in one or more embodiments. All optional features of the apparatus(es) described herein may also be implemented with respect to a method or process.

Example A01 includes a diffuser apparatus to be employed in an optical system, the diffuser apparatus comprises: a housing to hold at least one interaction element; a frame flexibly coupled to the housing, the frame is to hold a diffuser element; and at least one actuation element is included in or on the frame. During operation, the at least one actuation element actuates an interaction between the interaction element and the actuation element to produce movement of the diffuser element held in or on the frame with respect to the housing, and the movement of the diffuser element reduces speckle caused by laser light projected onto a surface of the diffuser element.

Example A02 includes the diffuser apparatus of example A01 and/or some other example(s) herein, further comprising: at least one suspension element, the at least one suspension element to flexibly couple the frame to the housing.

Example A03 includes the diffuser apparatus of example A02 and/or some other example(s) herein, wherein the frame comprises a hole configured to receive one end of the at least one suspension element, and the housing comprises a hole configured to receive another end of the at least one suspension element.

Example A04 includes the diffuser apparatus of examples A02-A03 and/or some other example(s) herein, wherein the at least one suspension element is oriented substantially perpendicular to the frame.

Example A05 includes the diffuser apparatus of examples A01-A04 and/or some other example(s) herein, wherein the at least one interaction element comprises one or more magnets.

Example A06 includes the diffuser apparatus of example A05 and/or some other example(s) herein, wherein the frame or a portion of the frame is a printed circuit board, and the at least one actuation element comprises one or more coils formed from one or more traces in the printed circuit board.

Example A07 includes the diffuser apparatus of example A06 and/or some other example(s) herein, wherein an arrangement of the one or more coils with respect to one another and with respect to the interaction element forms a linear drive mechanism.

Example A08 includes the diffuser apparatus of examples A06-A07 and/or some other example(s) herein, wherein actuation of the actuation element is based on a first magnetic field produced by the one or more magnets being repelled by a second magnetic field produced by the one or more coils.

Example A09 includes the diffuser apparatus of example A08 and/or some other example(s) herein, wherein an electric current supplied to the one or more coils is to produce the second magnetic field.

Example A10 includes the diffuser apparatus of example A09 and/or some other example(s) herein, wherein the electric current is to be supplied to the one or more coils using phase offset modulation, wherein a phase offset of the phase offset modulation is aligned with a resonance frequency of the diffuser device.

Example A11 includes an optical system, comprising: a light source arranged to generate light representative of at least one virtual image; an imaging matrix arranged to propagate the light as one or more wave fronts onto a display surface; and a speckle diffuser assembly disposed between the light source and the imaging matrix, the speckle diffuser assembly comprising: a housing, at least one interaction element attached to the housing, a diffuser element fixed to a frame, at least one suspension element arranged to flexibly couple the frame to the housing, and at least one actuation element included in or on the frame, wherein, during operation of the optical system: the generated light is to travel through the diffuser element onto the imaging matrix, the at least one actuation element actuates an interaction between the interaction element and the actuation element to produce movement of the diffuser element held with respect to the housing, and the movement of the diffuser element reduces speckle caused by laser light projected onto a surface of the diffuser element.

Example A12 includes the optical system of example A11 and/or some other example(s) herein, wherein the at least one suspension element is oriented substantially perpendicular to the frame.

Example A13 includes the optical system of examples A11-A12 and/or some other example(s) herein, wherein: the at least one interaction element comprises one or more permanent magnets or one or more ferromagnetic materials; the frame is a printed circuit board; and the at least one actuation element comprises one or more coils formed from one or more traces in the printed circuit board;

Example A14 includes the diffuser apparatus of example A13 and/or some other example(s) herein, wherein actuation of the actuation element is based on a first magnetic field produced by the one or more permanent magnets being repelled by a second magnetic field produced by the one or more coils.

Example A15 includes the optical system of example A14 and/or some other example(s) herein, further comprising: a controller arranged to control a flow of electric current supplied to the one or more coils to produce the second magnetic field.

Example A16 includes the optical system of example A15 and/or some other example(s) herein, wherein the controller is arranged to control the electric current supplied to the one or more coils using phase offset modulation, wherein a phase offset of the phase offset modulation is aligned with a resonance frequency of the diffuser device.

Example A17 includes the optical system of examples A11-A16 and/or some other example(s) herein, further comprising: an optical element through which the generated light is to be directed; and a projector arranged to project the laser light through the optical element and the diffuser element onto the imaging matrix.

Example A18 includes the optical system of examples A11-A17 and/or some other example(s) herein, wherein the display surface is a vehicle windshield, or the display surface is an electronic display element of a virtual reality headset.

Example A19 includes a diffuser to be employed in an optical system, the diffuser comprising: a diffuser screen embedded in a printed circuit board (PCB); one or more traces etched into the PCB, each trace of the one or more traces formed into one or more coils, wherein electric current to be supplied to each coil of the one or more coils produces a magnetic field; and one or more magnets facing, but not touching, respective coils of the one or more coils, wherein the one or more magnets produce another magnetic field to be repelled by produced by the magnetic field produced when the electric current flows through each coil, and wherein the one or more magnets and the one or more traces are arranged with respect to one another to produce a circular or elliptical motion when the magnetic fields repel one another.

Example A20 includes the diffuser of example A19 and/or some other example(s) herein, further comprising: a housing to hold the one or more fixed elements; and one or more suspension rods to couple the housing with the frame, a first end of each suspension rod of the one or more suspension rods is inserted into a corresponding via in the PCB, and a second end of each suspension rod is inserted is inserted into a corresponding hole in the housing.

Example A21 includes the diffuser of examples A19-A20 and/or some other example(s) herein, further comprising: one or more fixed elements to which individual magnets of the one or more magnets are attached, and each fixed element of the one or more elements overlapping a corresponding trace of the one or more traces.

Example A22 includes the diffuser of any one of examples A19-A21 and/or some other example(s) herein, wherein individual suspension rods of the one or more suspension rods are made of one or more of carbon, graphite, carbon fiber, fiber glass, ceramic filled polytetrafluoroethylene (PTFE), aluminum, alumina, polymide, polyvinyl chloride (PVC), polycarbonate (PC), polyimide(s), acrylonitrile butadiene styrene (ABS), polyetheretherketone (PEEK), polyaryletherketone (PAEK), polydiketoenamine (PDK), an oxide material, steel, carbon steel, spring steel, or a steel alloy.

Example A23 includes the diffuser of examples 19-22 and/or some other example(s) herein, wherein the one or more magnets are one or more permanent magnets, one or more ferromagnetic materials, or one or more electromagnets.

Example A24 includes the diffuser of examples A19-A23 and/or some other example(s) herein, wherein individual coils of the one or more coils are arranged in a rectangular coil pattern, a square coil pattern, a circular coil pattern, an elliptical coil pattern, or a meandering coil pattern.

Example A25 includes the diffuser of examples A19-A24 and/or some other example(s) herein, wherein an arrangement of the one or more coils with respect to one another and with respect to the interaction element forms a linear drive mechanism.

Example B01 includes a diffuser apparatus to be employed in an optical system, the diffuser apparatus comprises: housing means for holding interaction means; framing means flexibly coupled to the housing, the framing means for holding diffuser means; and actuation means included in or on the framing means, wherein the actuation means is for actuating interactions between the interaction means and the actuation means to produce movement of the diffuser means with respect to the housing, and the movement of the diffuser means is for reducing speckle caused by laser light projected onto a surface of the diffuser element.

Example B02 includes the diffuser apparatus of example B01 and/or some other example(s) herein, further comprising: suspension means for flexibly coupling the framing means to the housing means.

Example B03 includes the diffuser apparatus of examples B02-B03 and/or some other example(s) herein, wherein the suspension means is oriented is oriented in such a manner as to enable motion of the diffuser means.

Example B04 includes the diffuser apparatus of examples B01-B03 and/or some other example(s) herein, wherein the at least one interaction means comprises first magnetic field means.

Example B05 includes the diffuser apparatus of example B04 and/or some other example(s) herein, wherein the actuation means comprises second magnetic field means.

Example B06 includes the diffuser apparatus of example B05 and/or some other example(s) herein, wherein an arrangement of the first magnetic field means with respect to one another and with respect to the second magnetic field means is for forming a linear drive mechanism.

Example B07 includes the diffuser apparatus of examples B05-B06 and/or some other example(s) herein, wherein the first magnetic field means is for producing a first magnetic field and the second magnetic field means is for producing a second magnetic field, and the movement of the diffuser means is based on the first magnetic field being repelled by the second magnetic field and/or the second magnetic field being repelled by the first magnetic field.

Example B08 includes the diffuser apparatus of example B07 and/or some other example(s) herein, wherein an electric current supplied to the first and/or second magnetic field means is to produce the first and/or second magnetic field, respectively.

Example B09 includes the diffuser apparatus of example B08 and/or some other example(s) herein, further comprising: control means for controlling the supply of electric current to the first and/or second magnetic field means.

Example B10 includes the diffuser apparatus of example B09 and/or some other example(s) herein, wherein the control means is for controlling the supply of electric current to the first and/or second magnetic field means using phase offset modulation and/or pulse width modulation.

Example B11 includes the diffuser apparatus of example B10 and/or some other example(s) herein, wherein a phase offset of the phase offset modulation is aligned with a resonance frequency of the diffuser device.

Terminology. For the purposes of the present document, the phrase “A or B” means (A), (B), or (A and B). The phrases “A/B” and “A or B” mean (A), (B), or (A and B), similar to the phrase “A and/or B.” For the purposes of the present disclosure, the phrase “at least one of A and B” means (A), (B), or (A and B). The description may use the terms “embodiment” or “embodiments,” which may each refer to one or more of the same or different embodiments. Furthermore, the terms “comprising,” “including,” “having,” and the like, as used with respect to one or more embodiments, are synonymous, are generally intended as “open” terms (e.g., the term “including” should be interpreted as “including but not limited to,” the term “having” should be interpreted as “having at least,” the term “includes” should be interpreted as “includes but is not limited to,” etc.), and specify the presence of stated features, integers, steps, operations, elements, and/or components, but do not preclude the presence or addition of one or more other features, integers, steps, operations, elements, components, and/or groups thereof. The terms “comprises,” “comprising,” “includes,” and/or “including,” The phrase “in various embodiments,” “in some embodiments,” and the like are used repeatedly. The phrase generally does not refer to the same embodiments; however, it may. The present disclosure may use the phrases “in an embodiment,” “in embodiments,” “in some embodiments,” and/or “in various embodiments,” which may each refer to one or more of the same or different embodiments.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “fabrication” refers to the creation of a metal structure using fabrication means. The term “fabrication means” as used herein refers to any suitable tool or machine that is used during a fabrication process and may involve tools or machines for cutting (e.g., using manual or powered saws, shears, chisels, routers, torches including handheld torches such as oxy-fuel torches or plasma torches, and/or computer numerical control (CNC) cutters including lasers, mill bits, torches, water jets, routers, etc.), bending (e.g., manual, powered, or CNC hammers, pan brakes, press brakes, tube benders, roll benders, specialized machine presses, etc.), assembling (e.g., by welding, soldering, brazing, crimping, coupling with adhesives, riveting, using fasteners, etc.), molding or casting (e.g., die casting, centrifugal casting, injection molding, extrusion molding, matrix molding, three-dimensional (3D) printing techniques including fused deposition modeling, selective laser melting, selective laser sintering, composite filament fabrication, fused filament fabrication, stereolithography, directed energy deposition, electron beam freeform fabrication, etc.), and PCB and/or semiconductor manufacturing techniques (e.g., silk-screen printing, photolithography, photoengraving, PCB milling, laser resist ablation, laser etching, plasma exposure, atomic layer deposition (ALD), molecular layer deposition (MLD), chemical vapor deposition (CVD), rapid thermal processing (RTP), and/or the like).

The term “fastener”, “fastening means”, or the like refers to device that mechanically joins or affixes two or more objects together, and may include threaded fasteners (e.g., bolts, screws, nuts, threaded rods, etc.), pins, linchpins, r-clips, clips, pegs, clamps, dowels, cam locks, latches, catches, ties, hooks, magnets, molded or assembled joineries, and/or the like.

The terms “flexible,” “flexibility,” and/or “pliability” refer to the ability of an object or material to bend or deform in response to an applied force; “the term “flexible” is complementary to “stiffness.” The term “stiffness” and/or “rigidity” refers to the ability of an object to resist deformation in response to an applied force. The term “elasticity” refers to the ability of an object or material to resist a distorting influence or stress and to return to its original size and shape when the stress is removed. Elastic modulus (a measure of elasticity) is a property of a material, whereas flexibility or stiffness is a property of a structure or component of a structure and is dependent upon various physical dimensions that describe that structure or component.

The term “wear” refers to the phenomenon of the gradual removal, damaging, and/or displacement of material at solid surfaces due to mechanical processes (e.g., erosion) and/or chemical processes (e.g., corrosion). Wear causes functional surfaces to degrade, eventually leading to material failure or loss of functionality. The term “wear” as used herein may also include other processes such as fatigue (e.g., he weakening of a material caused by cyclic loading that results in progressive and localized structural damage and the growth of cracks) and creep (e.g., the tendency of a solid material to move slowly or deform permanently under the influence of persistent mechanical stresses). Mechanical wear may occur as a result of relative motion occurring between two contact surfaces. Wear that occurs in machinery components has the potential to cause degradation of the functional surface and ultimately loss of functionality. Various factors, such as the type of loading, type of motion, temperature, lubrication, and the like may affect the rate of wear.

The term “circuitry” refers to a circuit or system of multiple circuits configurable to perform a particular function in an electronic device. The circuit or system of circuits may be part of, or include one or more hardware components, such as a logic circuit, a processor (shared, dedicated, or group) and/or memory (shared, dedicated, or group), an Application Specific Integrated Circuit (ASIC), a field-programmable gate array (FPGA), programmable logic device (PLD), System-on-Chip (SoC), System-in-Package (SiP), Multi-Chip Package (MCP), digital signal processor (DSP), etc., that are configurable to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

As used herein, the term “element” may refer to a unit that is indivisible at a given level of abstraction and has a clearly defined boundary, wherein an element may be any type of entity. The term “entity” may refer to (1) a distinct component of an architecture or device, or (2) information transferred as a payload. As used herein, the term “device” may refer to a physical entity embedded inside, or attached to, another physical entity in its vicinity, with capabilities to convey digital information from or to that physical entity. The term “controller” may refer to an element or entity that has the capability to affect a physical entity, such as by changing its state or causing the physical entity to move.

The term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configurable to share computing and/or networking resources. Examples of “computer devices,” “computer systems,” etc. may include cellular phones or smart phones, feature phones, tablet personal computers, wearable computing devices, an autonomous sensors, laptop computers, desktop personal computers, video game consoles, digital media players, handheld messaging devices, personal data assistants, an electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

As used herein, the term “network element” may be considered synonymous to and/or referred to as a networked computer, networking hardware, network equipment, router, switch, hub, bridge, radio network controller, radio access network device, gateway, server, and/or any other like device. The term “network element” may describe a physical computing device of a wired or wireless communication network and be configurable to host a virtual machine. Furthermore, the term “network element” may describe equipment that provides radio baseband functions for data and/or voice connectivity between a network and one or more users. The term “network element” may be considered synonymous to and/or referred to as a “base station.” As used herein, the term “base station” may be considered synonymous to and/or referred to as a node B, an enhanced or evolved node B (eNB), next generation nodeB (gNB), base transceiver station (BTS), access point (AP), roadside unit (RSU), etc., and may describe equipment that provides the radio baseband functions for data and/or voice connectivity between a network and one or more users. As used herein, the terms “vehicle-to-vehicle” and “V2V” may refer to any communication involving a vehicle as a source or destination of a message. Additionally, the terms “vehicle-to-vehicle” and “V2V” as used herein may also encompass or be equivalent to vehicle-to-infrastructure (V2I) communications, vehicle-to-network (V2N) communications, vehicle-to-pedestrian (V2P) communications, or V2X communications.

As used herein, the term “channel” may refer to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” may refer to a connection between two devices through a Radio Access Technology (RAT) for the purpose of transmitting and receiving information.

The foregoing description of one or more implementations provides illustration and description of various example embodiment, but is not intended to be exhaustive or to limit the scope of embodiments to the precise form disclosed. Modifications and variations are possible in light of the above teachings or may be acquired from practice of various embodiments. Where specific details are set forth in order to describe example embodiments of the disclosure, it should be apparent to one skilled in the art that the disclosure can be practiced without, or with variation of, these specific details. The description is thus to be regarded as illustrative instead of limiting.

1-20. (canceled)

21. A diffuser apparatus to be employed in an optical system, the diffuser apparatus comprising:
a housing configured to hold at least one interaction element;
a frame flexibly coupled to the housing, wherein the frame is configured to hold a diffuser element;
at least one suspension element configured to flexibly couple the frame to the housing, wherein the at least one suspension element is oriented substantially perpendicular to the frame, the frame includes a hole configured to receive one end of the at least one suspension element, and the housing includes another hole configured to receive another end of the at least one suspension element; and
at least one actuation element is included in or on the frame, wherein:
during operation, the at least one actuation element actuates an interaction between the interaction element and the actuation element to produce movement of the diffuser element held in or on the frame with respect to the housing, and
the movement of the diffuser element is to reduce speckle caused by laser light projected onto a surface of the diffuser element.

22. The diffuser apparatus of claim 21, wherein the at least one interaction element includes one or more magnets.

23. The diffuser apparatus of claim 22, wherein the one or more magnets are one or more permanent magnets, one or more ferromagnetic materials, or one or more electromagnets.

24. The diffuser apparatus of claim 22, wherein the frame or a portion of the frame is a printed circuit board (PCB), and the at least one actuation element includes one or more coils formed from one or more traces in the PCB.

25. The diffuser apparatus of claim 24, further comprising:
one or more fixed elements held by the housing to which individual magnets of the one or more magnets are attached, and
each fixed element of the one or more elements overlapping a corresponding trace of the one or more traces.

26. The diffuser apparatus of claim 24, wherein an arrangement of the one or more coils with respect to one another and with respect to the interaction element forms a linear drive mechanism.

27. The diffuser apparatus of claim 24, wherein actuation of the actuation element is based on a first magnetic field produced by the one or more magnets being repelled by a second magnetic field produced by the one or more coils.

28. The diffuser apparatus of claim 27, wherein an electric current supplied to the one or more coils is to produce the second magnetic field.

29. The diffuser apparatus of claim 28, wherein the electric current is to be supplied to the one or more coils using phase offset modulation, wherein a phase offset of the phase offset modulation is aligned with a resonance frequency of the diffuser apparatus.

30. The diffuser apparatus of claim 29, wherein individual coils of the one or more coils are arranged in a rectangular coil pattern, a square coil pattern, a circular coil pattern, an elliptical coil pattern, or a meandering coil pattern.

31. The diffuser apparatus of claim 21, wherein the at least one suspension element is made of one or more of carbon, graphite, carbon fiber, fiber glass, ceramic filled polytetrafluoroethylene (PTFE), aluminum, alumina, polymide, polyvinyl chloride (PVC), polycarbonate (PC), polyimide, acrylonitrile butadiene styrene (ABS), polyetheretherketone (PEEK), polyaryletherketone (PAEK), polydiketoenamine (PDK), an oxide material, steel, carbon steel, spring steel, or a steel alloy.

32. An optical system, comprising:
a light source arranged to generate light representative of at least one virtual image;
an imaging matrix arranged to propagate the light as one or more wave fronts onto a display surface; and
a speckle diffuser assembly disposed between the light source and the imaging matrix, the speckle diffuser assembly comprising:
a housing,
at least one interaction element attached to the housing,
a diffuser element fixed to a frame,
at least one suspension element oriented substantially perpendicular to the frame and flexibly coupling the frame to the housing, wherein the frame comprises a hole configured to receive one end of the at least one suspension element, and the housing comprises a hole configured to receive another end of the at least one suspension element, and
at least one actuation element included in or on the frame,
wherein, during operation of the optical system:
the generated light is to travel through the diffuser element onto the imaging matrix,
the at least one actuation element actuates an interaction between the interaction element and the actuation element to produce movement of the diffuser element held with respect to the housing, and
the movement of the diffuser element reduces speckle caused by laser light projected onto a surface of the diffuser element.

33. The optical system of claim 32, wherein:
the at least one interaction element comprises one or more permanent magnets or one or more ferromagnetic materials;
the frame is a printed circuit board (PCB); and
the at least one actuation element comprises one or more coils formed from one or more traces in the printed circuit board;

34. The optical system of claim 33, wherein actuation of the actuation element is based on a first magnetic field produced by the one or more permanent magnets being repelled by a second magnetic field produced by the one or more coils.

35. The optical system of claim 34, further comprising:
a controller arranged to control a flow of electric current supplied to the one or more coils to produce the second magnetic field.

36. The optical system of claim 35, wherein the controller is arranged to control the electric current supplied to the one or more coils using phase offset modulation, wherein a phase offset of the phase offset modulation is aligned with a resonance frequency of the diffuser element.

37. The optical system of claim 32, further comprising:
an optical element through which the generated light is to be directed; and
a projector arranged to project the laser light through the optical element and the diffuser element onto the imaging matrix.

38. The optical system of claim 37, wherein the display surface is a vehicle windshield, or the display surface is an electronic display element of a virtual reality headset.

39. A diffuser to be employed in an optical system, the diffuser comprising:
a diffuser screen embedded in a printed circuit board (PCB), wherein the PCB includes one or more traces etched into the PCB, wherein each trace of the one or more traces are formed into one or more coils such that a magnetic field is produced when an electric current is supplied to each coil of the one or more coils; and
one or more magnets facing, but not touching, respective coils of the one or more coils, wherein the one or more magnets produce another magnetic field to be repelled by the magnetic field produced when the electric current flows through each coil,
wherein the one or more magnets and the one or more traces are arranged with respect to one another to produce a circular or elliptical motion when the magnetic fields repel one another, and the arrangement of the one or more magnets and the one or more traces forms a linear drive mechanism.

40. The diffuser of claim 39, further comprising:
a housing to hold one or more fixed elements to which individual magnets of the one or more magnets are attached, wherein each fixed element of the one or more fixed elements overlap a corresponding trace of the one or more traces; and
one or more suspension rods to flexibly couple the housing to the PCB, wherein a first end of each suspension rod of the one or more suspension rods is inserted into a corresponding via in the PCB, and a second end of each suspension rod is inserted is inserted into a corresponding hole in the housing.
